(19) United States
(12) Patent Application Publication
(10) Pub. No.: US 2022/0010930 A1
(43) Pub. Date: Jan. 13, 2022

(54) Systems and Methods for Converting Cryogenic Liquid Natural Gas to High Pressure Natural Gas and to Low Pressure Natural Gas using a Sphere Vessel and Retain all Product and to Further Dispense Only by Voluntary Actions of the User

(71) Applicant: Kenneth W. Anderson, Boerne, TX (US)

(72) Inventor: Kenneth W. Anderson, Boerne, TX (US)

(21) Appl. No.: 16/873,804

(22) Filed: Jul. 13, 2020

(51) Int. Cl. F17C 3/08; F17C 5/06

(52) U.S. Cl. CPC F17C 3/08; F17C 5/06; F17C 2223/0161; F17C 2225/036; F17C 2270/0509; F17C 2225/0123; F17C 2203/0391

(57) ABSTRACT

A System to convert and dispense pressurized gas(es) of cryogenic liquids of gas(es), and systems and methods using a sphere pressure vessel to efficiently convert liquid natural gas (LNG) to compressed natural gas (CNG) and low pressure natural gas (NG) and other cryogenic liquids of gas. The system requires one dedicated sphere pressure vessel at the dispensing location and the location of elements according to horizontal and vertical orientation to convert, retain, store, and dispense multiple pressures of gas from a cryogenic liquid supply such as a non-dedicated high pressure cryogenic personal supply tank. The system efficiently modifies and controls parameters of volume, pressure, and temperature in conversion scale to retain all converted product under human control to dispense, without process required waste, for use in commercial, utility and industrial uses, and scaleable for single family residential applications where service can be accomplished by pickup truck and trailer, where semi trucks access is not available.

### CROSS REFERENCE TO RELATED APPLICATIONS

Applicant claims the priority of the following related applications.

This application is a Continuation-In-Part of Ser. No. 15/834,737, Filed on Dec. 7, 2017 (which published as US 2018/0119885, and issued as U.S. Pat. No. 10,753,540), which is a Continuation-in Part of application Ser. No. 14/397,457, Filed on Oct. 27, 2014, now Abandoned, filed as Application No. PCT/US13/38291 on Apr. 25, 2012. Provisional Application No. 61/637,908 was filed on Apr. 25, 2012.

### BACKGROUND OF THE INVENTION

The present invention relates generally to processing cryogenic liquids to gas efficiently using, recycle centric systems using the sphere shape for a pressure vessel fabrication, shipping, storage, and footprint, which is a sphere to use for efficiently converting batches or continuous streams of the cryogenic liquid of a gas into a beneficial pressurized gas such as liquid natural gas (LNG) to compressed natural gas (CNG), also known as pressurized natural gas (PNG), and further to low pressure natural gas (NG). The present invention relates more specifically to a system for efficiently modifying and controlling the parameters of volume, pressure, and temperature including converting liquid natural gas (LNG) to low pressure natural gas (NG) for the purpose of storing and dispensing of each of the same for use in commercial applications. The invention further relates the need to scale to a single user's gas needs, and to further dispense only by voluntary actions of the user and not forced by process use or required “deinventory” pollution venting or low value forced dispensing. This issue relates well in a variety of commercial and industrial applications needing clean small scaleable dispensing of CNG to promote natural gas for vehicle fueling infrastructure, and those customers stranded from natural gas pipelines. The invention can also be used in the service of pipelines as a method to push product in the instance of the petroleum pipeline such as a compressor would. For water pipelines the invention could be used in the making of and motivation of ice pigs for the purpose of cleaning the inside of water lines. The safety focused present invention provides for the Flange GuardX which is usable on flanges of the invention and elsewhere where flanges are used. The present invention also converts the cryogenic liquids of other gases into a beneficial pressurized gas such as Argon, Nitrogen, Oxygen, or the gas of the air liquified cryogenically and other gasses. The present invention can be used just as a pipeline compressor only without electrical utilities, injecting Nitrogen or Natural Gas into a pipeline to move product. The present invention serves the unserved and under-served markets including those markets without infrastructure pipelines, or electrical utilities interrupted supplies, and those with emerging small scale needs which can be scaled as markets grow. The invention will be used as a negotiating tool to control overcharging by pipelines, since the invention can be used to deliver many of the same products and competition may form between this product and a company with pipelines.

### DESCRIPTION OF THE RELATED ART

No efforts, known to the inventor have been successfully made in the past to convert LNG to CNG or other cryogenic liquids into high pressure gas in a high pressure sphere pressure vessel and retain all converted product, dispense multiple pressures, and to further dispense only by the actions of the user using a single container dedicated to the point of dispensing. A few efforts have been made in the past to efficiently store and convert liquid natural gas (LNG) to compressed natural gas (CNG) pressure and then to dispense it as low pressure natural gas (NG). Except for those efforts accomplished by the present inventor, these efforts suffer from significant losses and dependence on distributed heat energy during the processes of compressing and/or decompressing the systems from required process dispensing or venting “deinventory” pollution or use extra pressure building devices to move LNG from one container to another and require more than 6 containers. Quine U.S. Pat. No. 6,474,101, requires 8 containers: 6 CNG Tanks, 1 LNG Storage Tank and 1 LNG/CNG Converter for example, and his 1,000 gallon gasifier LNG/CNG Conversion unit with 4,999 psi of methane must be decompressed by forced dispensing or venting down to 50 psi before his 3,000 gallon LNG Storage Tank is able to move LNG to his gasifier, and his 3,000 gallons of LNG if not processed will vent out of his LNG Storage Tank into the open air. Quine's full scale service station further requires bulk highway semi truck deliveries of LNG. His LNG Storage Tank container and piping and pipe pressure relief specifications do not allow movement of high pressure gas into his LNG Storage Tank, so for Quine's art, small scale dispensing or the retention of all gasification from LNG to CNG or moving CNG from LNG-CNG Converter to LNG Storage Tank is impossible.

Although natural gas use has and appears will continue to increase, the ability to store, transport, and convert the low volume high quantity forms of natural gas has lagged behind and inhibited demand for natural gas in a variety of applications, particularly home fueling, and commercial dispensing of small volumes of CNG that scale as the volume of CNG vehicle demand grows. Currently all CNG fueling at a residence requires a natural gas distribution pipeline. This eliminates about 25% of U.S. population whose homes do not have natural gas delivered by pipeline. For those fortunate to have a natural gas pipeline distribution, small scale CNG fueling requires a compressor connected to the natural gas pipeline supply to the house and filling a NGV (Natural Gas Vehicle) overnight. Reliability of these compressors is problematic because of the amount of time that it takes to fill and variations in quality of pipeline natural gas. Full scale compressor service stations are available for about $500,000-$750,000 and are more reliable, but require many customers to be profitable and require commercial and industrial locations and large natural gas pipelines or semi truck traffic to serve them. Such storage, transportation, and conversion problems have become especially acute in the smaller residential applications associated with the use of natural gas and the use of semi trucks in residential neighborhoods and/or rural roads. There is no spherical LNG-CNG-NG conversion system for a single customer's needs. There is no LNG-CNG conversion system of 2 containers, of which 1 is a sphere high pressure vessel dedicated for converting, retaining and dispensing high pressure for vehicles and typical and low pressure gas NG utilities scaled for the single residence save this present best invention. Absent a natural gas pipeline, there is no delivery available of natural gas in the safe CH4 (methane/NG) chemistry which does not pool on the ground or on water in the event of a leak. CH4 (methane/NG) is lighter than air; however, other forms of NG can pollute the ground or water. The ability to efficiently cut, weld, fabricate, recycle, store, transport, and convert natural gas (typically in the form of CNG or LNG) has inhibited the ongoing growth of the natural gas industry for use in residential and micro commercial applications. The micro commercial conversion and dispensing of other gasses such as atmospheric gas from its cryogen or Nitrogen for such as for filling pneumatic automobile tires at a self serve gas station or as a pneumatic gas moving mining equipment underground is an additional market and use for the present best invention.

### SUMMARY OF THE INVENTION

The present best invention of the spherical cryogenic liquid of a high pressure gas processor to pressurized gas dispenser uses the most efficient fabrication shape for a pressure vessel. The Sphere shape has one weld and the smallest ratio of welding seam length per volume. The present invention conserves the metal resources of the sphere to be recycle centric being made of the same materials for the pressure vessel stand as for the pressure vessel, using more than 89% of a single plate for a vessel. The fabrication of the best invention materials are chosen to provide one safe recycle centric equipment package when assembled is transportable by a pickup truck and trailer, and being capable to process cryogenic liquids originating at the liquification point of Nitrogen at −320 F degrees and capable of delivering gases such as a 5,000 psi stream for dispensing can be obtained from Stainless Steel. A single dedicated container at the place of dispensing using designated internal component horizontal and vertical locations will dispense gas at the customers' desired pressures without process waste. The liquid and gas movement and the density and pressure is controlled by design volume ratios using retained gases from previous processing's ambient heat as well as the pressure vessels thermal mass as a heat sink for warming cool gasses. The invention includes all of the elements for the liquid cryogenic to gas conversion, and retaining and separating liquid from gas, cold and warm, and using the density orientation as an ambient temperature pressurized gas conversion system with confirmation instrumentation with communication for using a cryogenic liquid such as a LNG to CNG conversion system. Other optional gas supplies and backup systems, and methods for adding other elements of gas to enhance or alter flame characteristics while requiring no gas source pipeline may further enhance the inventions usability.

In mathematical parameters the present invention Containers and vessel sizes can be adjusted to supply customers' desired valuable pressure and volume. To deliver LNG and dispense CNG at 3000-3600 psi the present invention container size ratios of 1:21:2.4 between the LNG supply and the dedicated sphere container is desirable and results in valuable pressures. The present best invention is the best invention to convert other cryogenic liquids into pressurized gas to dispense. The ratio of expansion of the cryogen must be taken into account, for example Nitrogen expands at a ratio of 700:1. LNG expands at a ratio of 600:1. This affects the size of all containment as well as the ratios between them. The desired delivery pressure of the process gas must also be taken into account. The desired amount of process gas to have on hand can be adjusted by the size of the pressure vessel. In use the process container ratios for best performance must be adjusted based on the expansion ratio of the cryogenic liquid of the gas as compared to the pressurized gas and the amount of gas already in the system.

Piping for Gravity movement of liquids of gas can be done by adding cryogenic liquid to the invention's cryogenic liquid to gas processor. In high pressure movement between two containers piping between containers must be two way to permit gas to balance pressure allowing the container with cryogenic liquid, which is at a superior elevation, to flow into the inferior elevation container. In this way batches of cryogenic liquid can be moved into the processor. Piping must not contain pressure relief valves of a pressure which is less than the balancing pressure of the first undedicated container and the second dedicated container or pollution or waste will occur. For the present invention a continuous stream of cryogenic liquid can be moved into the processor with a power supply and an injection pump or high pressure cryogenic pump. In that high value cryogenic storage may maintain liquids longer than a month injection charging may be best for high volume gasification use.

Container Sizes for Argon and Nitrogen Cryogenic Liquids and Specification Limitations. As a result for this present best invention, the personal supply Container 1 as described for LNG would be smaller for Nitrogen by approximately 14% and for Argon 30% smaller. The expansion rate of Cryogenic CH4 LNG is 600:1, Argon (Ar) is 847:1, and Liquid Nitrogen (LN) to Nitrogen (N) is 700:1. In addition there are known expansion ratios of all gasses which can be compressed to cryogenic liquid including any mixture of the air's gases that make up the atmosphere. The expansion rate assumes one atmosphere of pressure and is not exact because of the presence of impurities, variations, and variations of isotope chemistry. The desired pressure for dispensing as well as the typical amount of residual gas left over from previous conversions in the dedicated container where dispensing occurs, the value of the product gas, the temperature of conversion of a gas into its phase change cryogen, and the containment costs are relevant for obtaining strategic pressures of certain cryogenic gasses using this best invention. Nitrogen is known to be marketed at 200-300 bar. Argon is known to be marketed at 135-275 bar. A custom container of the present best invention intending to dispense Argon for a low pressure market may have a benefit to reducing the size of the dedicated 2nd container by 30% and still serve the market for dispensing Argon. Generally the size of the dedicated container could be increased or decreased by a ratio based on whether the anticipated goal dispensing was to occur above or below 3,500 psi, the goal dispensing pressure of LNG of the present best invention. Some specifications of containers do not allow high pressure, such as LNG Storage tanks where the design is such to preserve a cryogen for a month at a time by increasing insulation and decreasing thermal transfer by reducing the thickness of the container, which limits strength for containing pressure. Gas law requires a pressure balance between two containers before liquid can gravity flow between them.

Cryogenic Liquid Gasification/Conversion. Gasification, using gas from previous conversions and containment as a heat sink. Gas from previous gasifications which is within the dedicated container further serves to aid in conversion of cryogenic liquid to gas by balancing temperatures between the density and temperature of the cryogenic liquid verses the density and temperature of the ambient gas when the result is fully contained.

Warming to enhance gasification can also occur by using a refrigeration loop using such as Nitrogen as refrigerant which captures a potentially high value cryogenic cold and moves it to a high value use such as making ice in a location such as a convenience store or cooling the store itself, providing a retail location a conditioned space for beneficial use. The value of this secondary cogeneration refrigeration at times has a higher value potential in comparison with the value of a gas converted from a cryogen.

The function of the internal cryogenic container in the present system is to isolate, in a practical cost efficient manner, the cold cryogenic liquid such as LNG and allow the LNG to vaporize in contact with previously vaporized gases first without touching the outside of the vessel. This lessens possible metal stress that could occur from a localized cold spot on the pressure stressed vessel exterior, which could result in system life shortening metal fatigue. In the present best invention beneficial separation of liquid from gas especially occurs in the mixing of the existing left over warm gas with cold liquid resulting in cold gas and colder gas and then the equalization of the temperature of all gas which occurs immediately, following the laws of gas. Optionally, a vertical vessel may be added and making warming gas follow and climb a circuitous path or a vertical rise and fall physically promotes the physical separation of liquid from warming gas and dry gas for dispensing at the high vertical end which would also serve to aid in homogenizing multiple chemistries present in cryogenic gasses including natural gas such as propane, ethane, butane, etc.

The system of the present invention will be used in a primary way to fuel natural gas CH4 (methane) for transportation vehicles such as cars, trucks, carts, lifts, cycles, etc. The system of the present invention using N (nitrogen) will be used to push products through pipelines and clean pipelines, including making ice pigs. The present invention's gas molecules can also be used as a feed stock for hydrogen production. The natural gas made ready for use by the system of the present invention is likely superior to fuel supplied by non-LNG “natural gas” or mixed LNG sources and natural gas together, because it will be chemically more homogeneous and in processing a cryogenic water is removed in the freezing. Liquid distillates, such as butane, ethane, and propane, which can settle out of methane vapor in excess proportions, are removed in the production of LNG when they freeze or separate during the refrigeration process making a cryogenic liquid from a gas; and as a result, these impurities are prevalent in the system's fuel production in known proportions. As opposed to other fueling equipment, the fuel supplied by the system of the present invention is superior because it begins with LNG which is more homogeneous than natural gas from an older pipeline and does not begin as residential NG and may likely be chemically altered with operant sulfur or other chemicals known in the art. This avoids gas streams which contain water which can foul equipment using the gas streams. The methane fuel, when used, can easily be additionally enhanced by the addition of hydrogen or other elemental gas such as Argon or Nitrogen or molecules to alter flame characteristics for custom requirements when they are desired, using the present best invention gas or liquid ports to enter the dedicated container located at the dispensing location.

The system of the present invention will be used also to convert cryogenic Argon to pressurized gas for use, including as an additive for CH4. The system of the present invention will be used also to convert cryogenic Nitrogen to pressurized gas for use. The system of the present invention will be used also to convert a cryogenic mixture of air gasses. Cryogenic Nitrogen or the cryogenic liquid of air of gasses will be used, including in coin operated dispensing to fill pneumatic tires located typically where retail gasoline is sold. It will be used to motivate a mobile platform using pneumatics with a non combustible gas underground, the air's gasses as a cryogen may be ideal for this effort. The current invention will also be used to convert cryogenic Oxygen to gas for use in the medical environmental as well as a flame control for a wide variety of uses including smelting and casting. Each cryogenic gas has a different ratio of expansion from liquid to gas which will determine the best container size ratios to result in a beneficial pressure result for ambient temperature “warm” gas.

The system of the present invention will be used as a transportation compressed natural gas (CNG) or pressurized natural gas (PNG) fueling station. The system of the present invention will further be used as a natural gas supply (NG) such as for a residence. The system of the present invention will be used as a reserve backup natural gas supply such as for a residence for purposes including emergency, as well as being an emergency energy backup supply for food or medical facility energy requirements. It will also be used as the source of energy for generating other forms of energy such as powering a gas turbine generator to make electricity or to power a hybrid natural gas over electric motor or to charge an electric car. The system of the present invention will be used as the source gas or a supplemental natural gas supply point for a natural gas distribution system. The system of the present invention will be used as a point of sale of natural gas and other converted gasses from cryogenic liquids. The system of the present invention will be used for peak supply storage of natural gas. Isolated property owners with access but without electrical utilities or heat utilities will use this present invention where no natural gas pipelines exist or where they cease to function and this best invention becomes the sole source supply of energy for an area.

This invention is scalable to allow dimensional changes which result in different beneficially targeted volumes and pressures by adjusting the ratio between the size of the first container cryogenic liquid receiver to the second container liquid to gas gasifier, taking into account the expansion ratio of the cryogenic liquid, and the target contained pressure range of the resulting gas product for increased usefulness. Adding additional dedicated containers at a single location is anticipated, because it allows “cool full fill™” dispensing, and because it allows one half of the equipment to be converting from a cryogen to pressurized gas while the other half is dispensing previously processed warm gas. The result will always be that the first container will be smaller than the second container, and for methane, if the target pressure sought is about 3,500 psi since the expansion of methane is approximately 600:1, the size ratio between the second larger container and the first smaller container calculates to between 2-2.4:1. The invention's most beneficial scaling is in providing smaller scale use which benefits from not using semi trucks especially where their use is impractical, illegal, or unwelcome. The invention does up scale from a commercial micro dispensing size by the addition of a multiple of the same class of the on site dedicated containers. Two or three dedicated gasifier converter dispensers can be joined to accomplish a unique cold cascade dispensing. Low cost CNG storage can also be easily incorporated in the process of scaling this invention but for improved security it is elevated by creating a floor supported by the upper vertical element of the dedicated container.

### BRIEF DESCRIPTION OF THE DRAWINGS

FIG. 1A is a top view of the cutment layout of a plate pattern for parts.

FIG. 1B is a side view of the showing the corresponding layout of the cutment pattern parts.

FIG. 1C is a partial view of the bottom hemisphere of first embodiment of the invention.

FIG. 1D is a partial view of the top hemisphere showing instrumentation of the first embodiment of the invention.

FIG. 2A is a side view of the first embodiment of the invention.

FIG. 2B is view of the interior of the spherical pressure vessel of the invention.

FIG. 2C is a side view of the 4 leg stand of the first embodiment of the invention.

FIG. 2D is a bottom view of the 4 leg stand of the first embodiment of the invention.

FIG. 3 is a side view of the front of the second embodiment of the invention.

FIG. 3A is a top view of the flange showing piping of the second embodiment of the invention.

FIG. 3B is a view of the flange assembly of the second embodiment of the invention.

FIG. 3C is a side view of the 3 leg stand of the second embodiment of the invention.

FIG. 3D is a bottom view of the 3 leg stand of the second embodiment of the invention.

FIG. 4A is a view of the third embodiment of the invention.

FIG. 4B is a top view of the flange of the third embodiment of the invention.

FIG. 4C shows two optional configurations of the interior of the vertical pressure vessel of the third embodiment of the invention.

FIG. 4D is a side view of the 3 leg stand of the third embodiment of the invention.

FIG. 4E is a bottom view of the 3 leg stand of the third embodiment of the invention.

FIG. 5 is an exploded view of the instrumentation located on the invention.

FIG. 6 shows the first embodiment of the invention being employed in a marine environment.

FIG. 7 shows the first embodiment of the invention being employed in mining operations.

FIG. 8 is a cut-away view of the second embodiment of the invention, the second embodiment being employed to cool a cabinet by thermal transfer.

FIG. 9 is a view of the second embodiment of the invention to cool a refrigerator/freezer by refrigeration absorption.

FIG. 10 shows multiple views of an accessory called Flange Guardx to protect flanges from mischief and to “tell” on fugitive emissions.

FIG. 11 is a view of a natural gas powered vehicle employing either the first, second or third embodiments of the invention.

FIG. 12 is a side view of the second embodiment of the invention being employed moving Waterline ICE Pigs in a pipeline.

FIG. 13 is a view of the third embodiment of the invention being employed to move oil in a pipeline.

FIG. 14 A is a first view of a portable LNG supply tank.

FIG. 14 B is a second view of a portable LNG supply tank.

FIG. 14 C is a third view of a portable LNG supply tank.

FIG. 14 D is a fourth view of a portable LNG supply tank.

FIG. 15 shows how invention may be implemented, and utilized from LNG plant production to residential uses.

FIG. 16 shows an alternate embodiment of the invention.

FIG. 17 A shows two mobile cryogenic fueling containers which may be employed with the invention.

FIG. 17 B shows an L shaped embodiment of an LNG-CNG-NG processor dispenser.

FIG. 17C shows two optional configurations of the interior of the vertical pressure vessel as described in FIG. 17B.

### DETAILED DESCRIPTION OF THE DRAWINGS

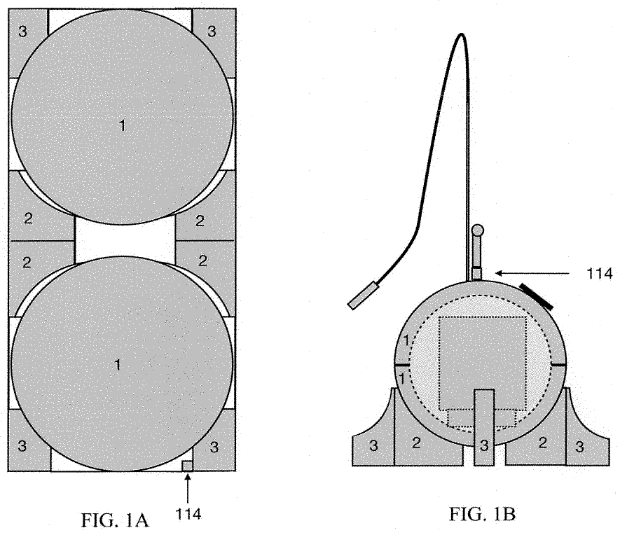

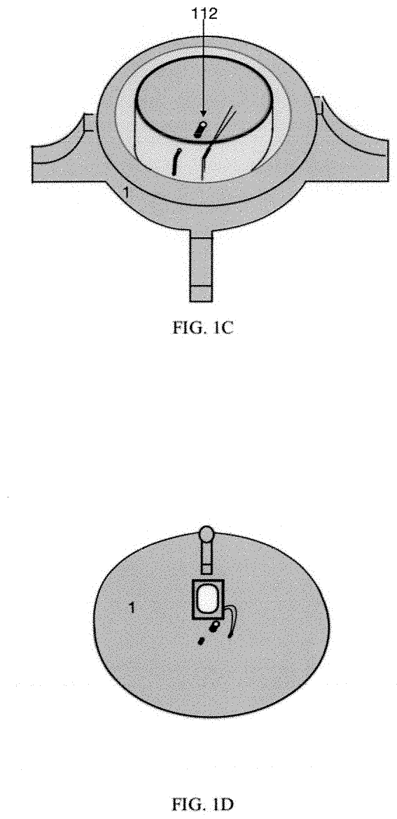

FIG. 1A is a view of the present invention for converting a cryogenic liquid into a pressurized gas, showing elements 1,2 and 3 of the plate cutment pattern to obtain 89% beneficial use of a plate in fabrication FIG. 1B shows a cutaway view of the first embodiment of the invention with a 4 leg stand also showing the inside cryogenic container. It further shows the location of the pattern pieces in the invention. FIG. 1C shows the inside view of the legs and lower head formed from the plate and the interior location of the penetrations with their relationship of the penetrations and the associated piping with the cryogenic interior container and the inside of the outer shell (head). FIG. 1D shows the exterior of the upper head 1 of the invention showing the relationship with the outer penetration fixtures. The present invention shows in FIG. 1A, a top view plate cutment pattern, FIG. 1B, side cutaway view, cutment pattern placement, FIG. 1C elevated prospective of bottom head, and in FIG. 1D elevated prospective of top head. The invention provides LNG to CNG to NG system and method using the most material thickness efficient shape for a high pressure vessel which is a sphere. Formed spherical pressure vessels are made from steel flat plates as shown in FIG. 1A, which are easier to produce in high quality and then confirm by a quality control check. A sphere shape begins with a round blank which is most often formed hot around a die shape to make a head which is one half of the sphere, and generally referred to as a hemi head. Two heads, shown in FIG. 1C and FIG. 1D are welded together at their edge make a sphere. The resulting waste of cutting a circle from a square of metal yields about 23% scrap steel which has very little value even though cryogenic rated pressure vessel steel is very expensive because each steel has a specific chemistry and a pile of typical scrap has many chemistries and its value is the value of the least valuable piece in that pile. This reduces the scrap to less than 11% providing a vessel stand with extra stability with a lower center of gravity This allows for future efficient recycling of valuable steel used in the fabrication of the invention.

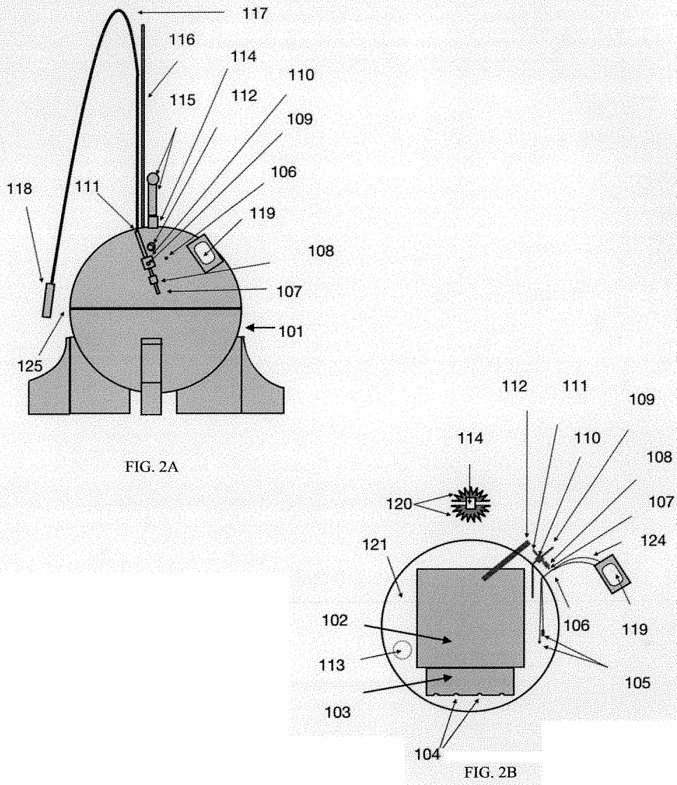

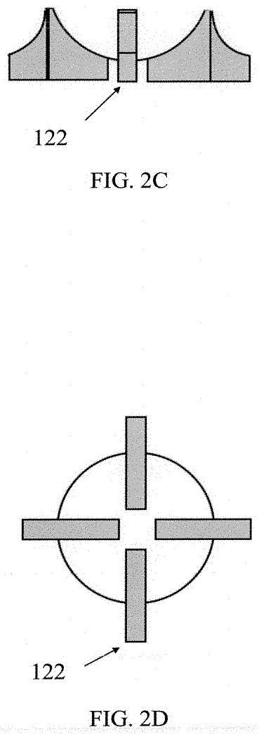

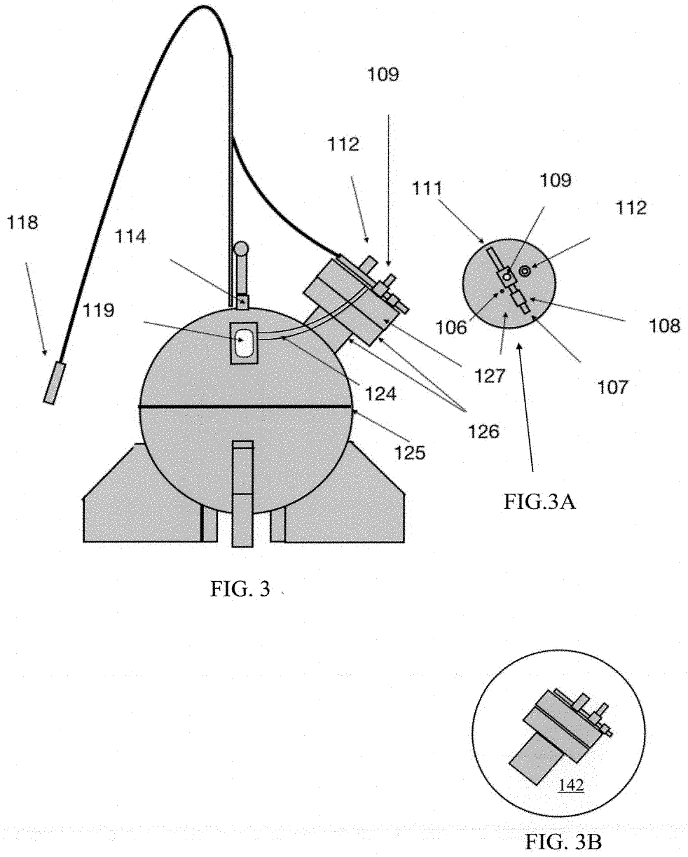

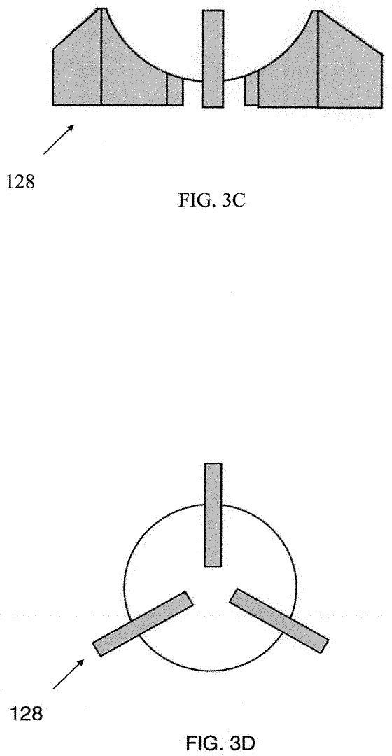

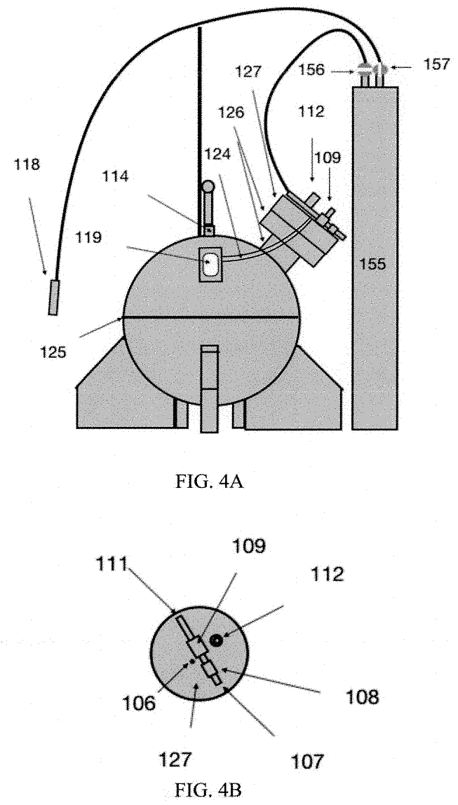

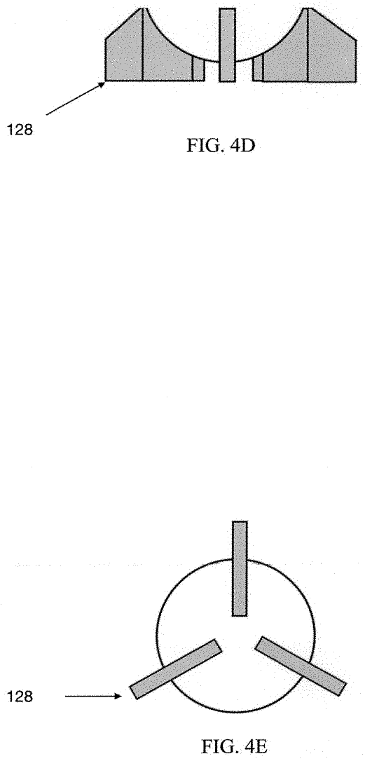

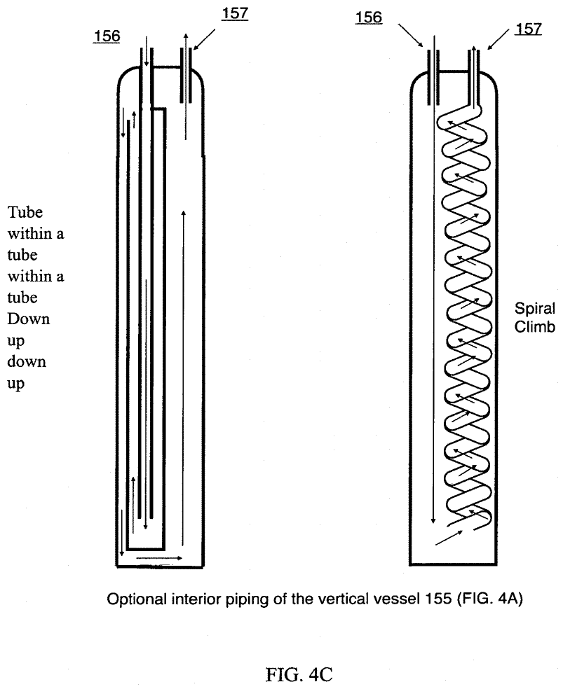

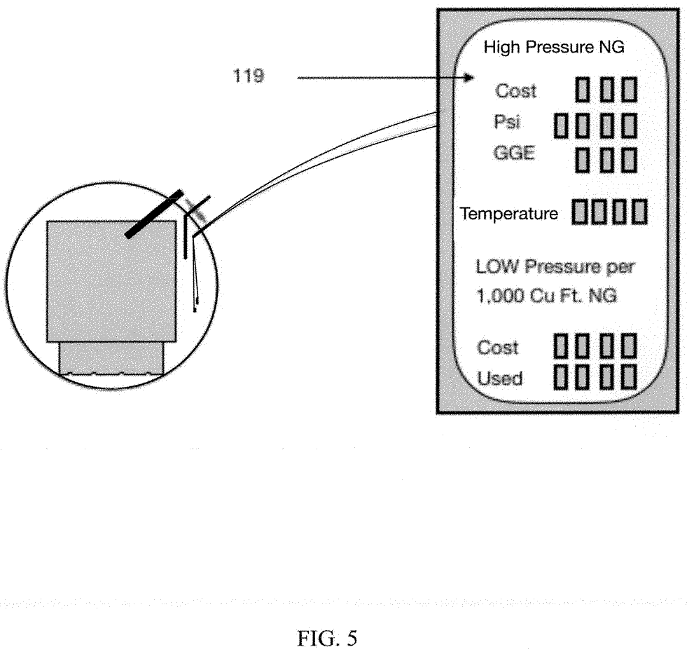

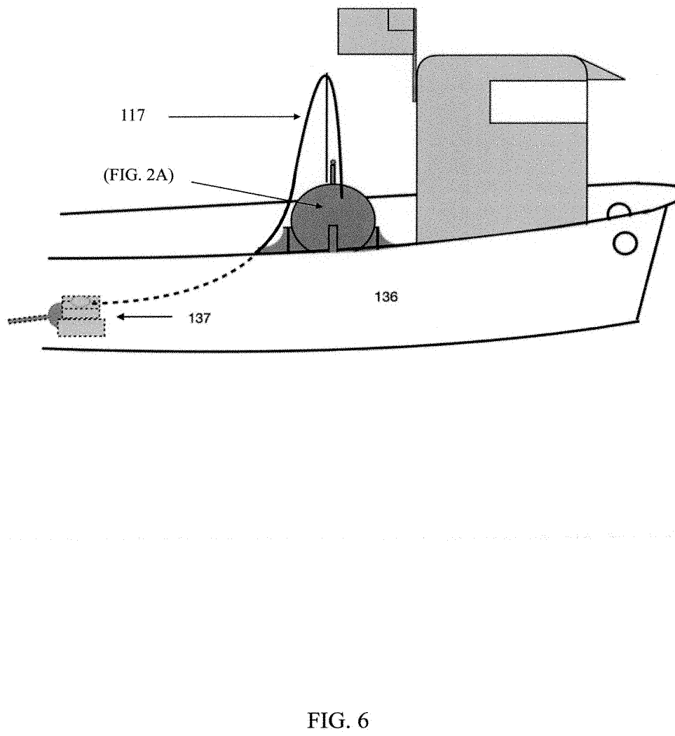

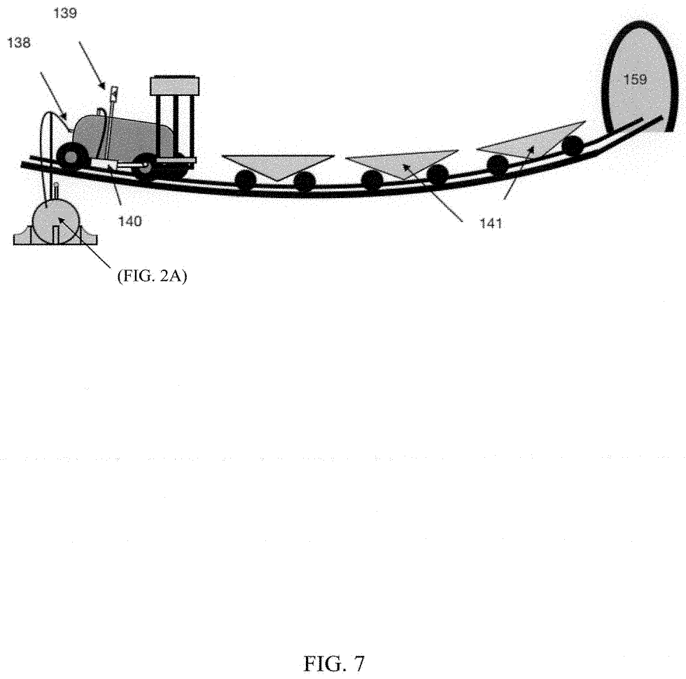

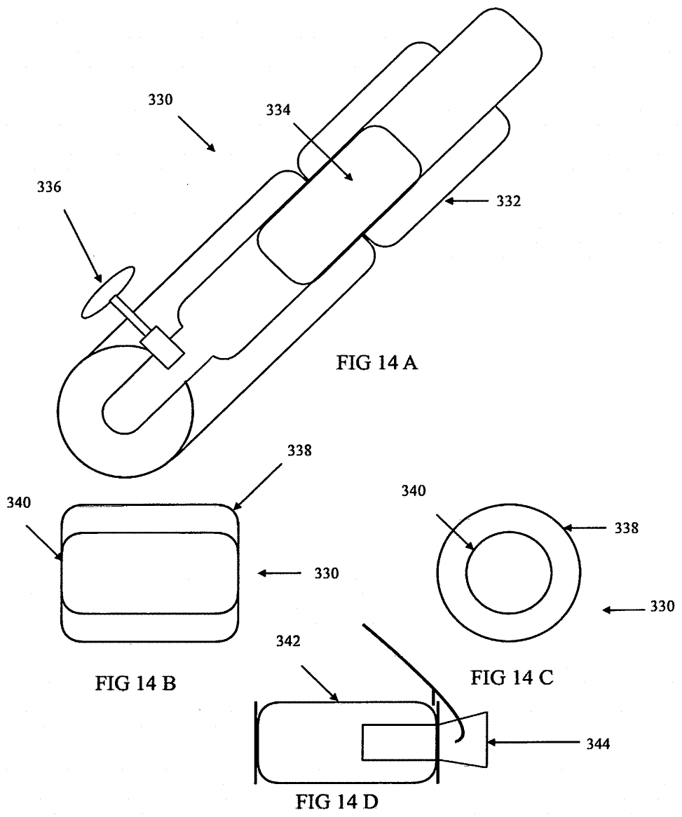

FIG. 2A shows the first embodiment of the invention. FIG. 2B is a cut away view of the first embodiment of the invention. This view delineates the core of the invention. FIG. 2C is a side view of a 4 leg stand of the first embodiment of the invention. FIG. 2D is a bottom view of the of the 4 leg stand of the first embodiment of the invention. Referring to FIG. 2A, a cryogen is introduced from outside (101) the spherical pressure vessel into the inside of the spherical pressure vessel through the one way valve penetration and associated pipe (112) from a source such as a personal cryogenic supply container (an example is shown in FIGS. 14A-D or a high pressure cryogenic pump and IMO (Intermodal container) reservoir. Prior to the movement of liquid from one tank with pressure to another tank with pressure there must be equalization of pressure. Connecting the two containers at the two way gas pipe (109) accomplishes the path for this to occur, and when equilibrium is obtained a cryogen can flow in at (112) and into the internal cryogenic container (102). The outside in the placement of penetrations and the associated piping which pass through the spherical high pressure vessel are functionally important. The operation of the invention requires their precise location and angle with respect to the spherical high pressure vessel. The penetration in the upper quadrant of the pressure vessel and piping for cryogenic liquids of a gas such as LNG (Liquid Natural Gas) shown as element 112 in FIG. 2B are one way in valved and associated pipe terminates to direct the stream into the interior container (102). The two way penetration and piping for gas (109), being the gas of the cryogen such as high pressure natural gas if the cryogen is LNG penetrates the pressure vessel in the upper quadrant and terminates at an angle to not terminate into the interior container (102). Additionally, the penetration for sensors and sensor leads which brings in these items for the purpose of understanding the current interior conditions of at least temperature and pressure must not be directed at the interior container (102) and terminate at a different elevation than the interior extent of the two way gas pipe (109). The spherical pressure vessel has a hollow interior (121) where there is a weight of gas of the cryogen left over from previous processing (113) and generally not less than 30%-40% of the capacity rating of the pressure vessel by pressure, and in the lowest quadrant there is a cylindrical internal vessel stand (103), having scallop voids on the bottom edge to allow gas to circulate through it, and capable of supporting the internal cryogenic container (102) at full weight. Now that the hollow interior 121 is filling with gas, an absence of outside heat or cold the mass of an object will seek the ambient temperature. Any gas found colder than the current ambient temperature of the gas in the interior will be further warmed by the heat sink of the mass of the spherical pressure container's thermal mass, until they are equal. The ratio of weight between the weight of the spherical pressure container and its interior gas weight is approximately 20 lbs. per pound of gas. High pressure dispensing as shown in FIG. 2A shows how high pressure gas is dispensed through a quick connect nozzle (118) using a flexible hose (117) connected to high pressure pipe outlet (111). An optional high pressure pipe branch may be located at this location to increase the number of high pressure outlets. Low pressure gas is dispensed through low pressure gas pipe (107). An optional low pressure pipe branch may be located at this location to increase the number of low pressure outlets.

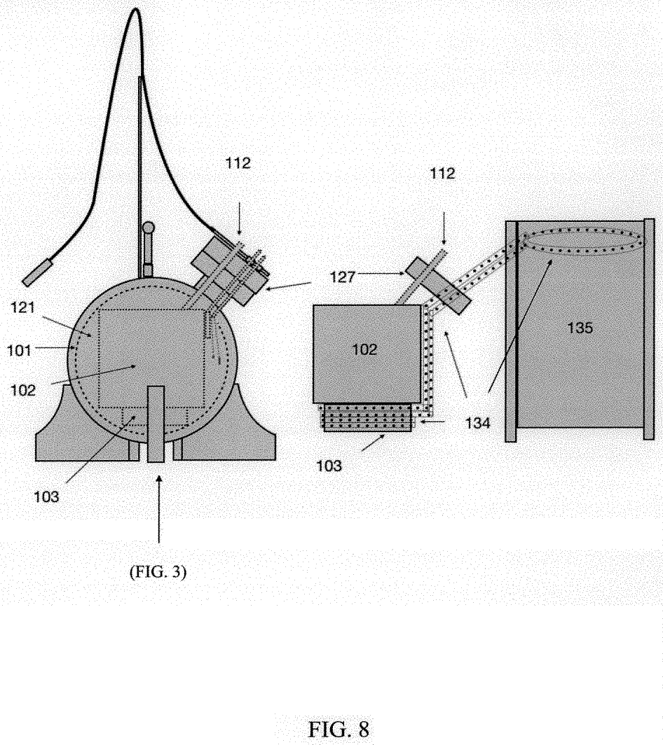

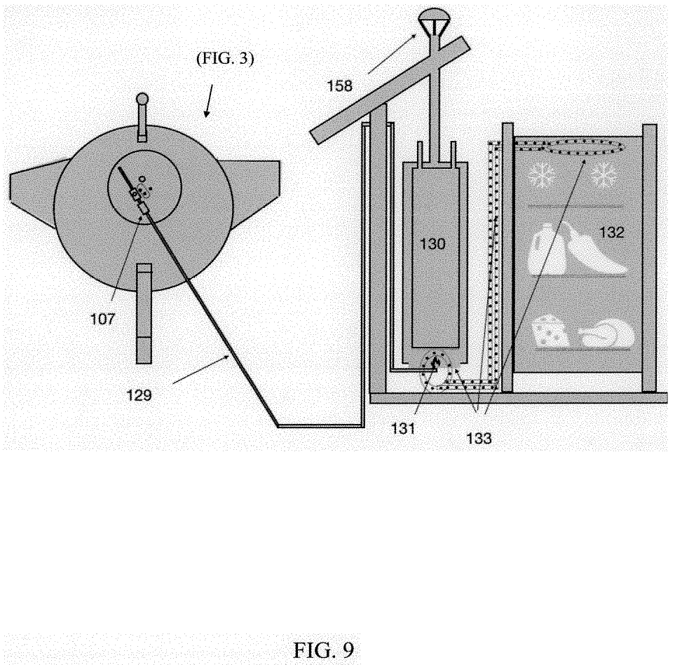

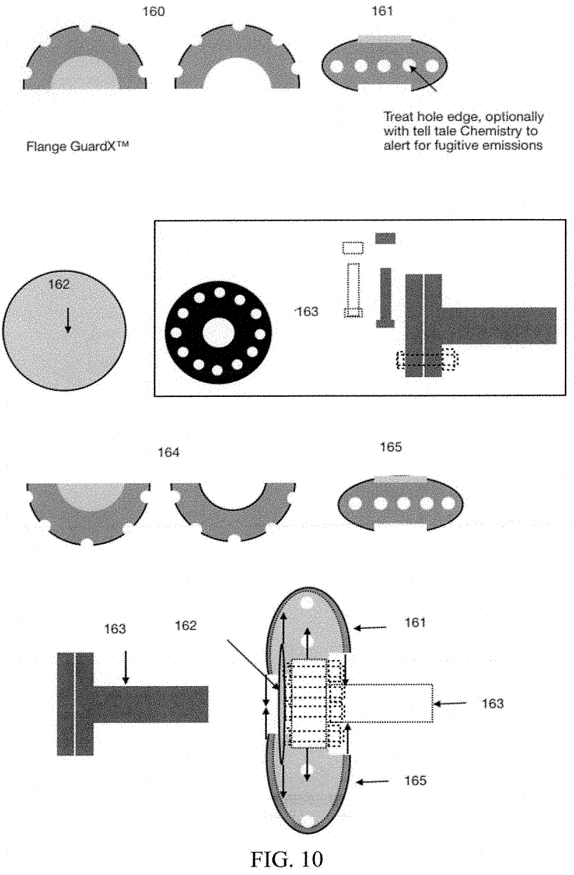

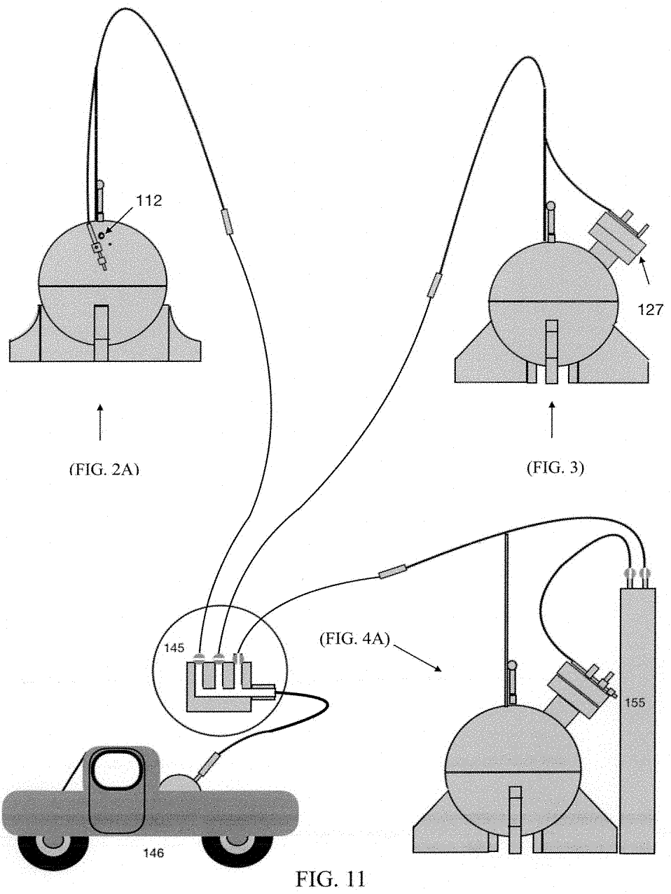

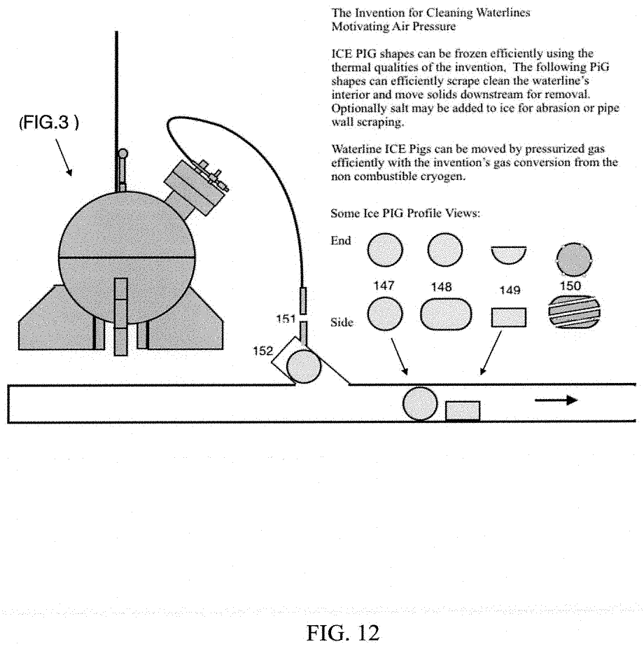

FIG. 3 shows a view of the second embodiment of the invention. This embodiment includes a flange fitting 126 and a 3 leg stand 128 as shown. This embodiment includes a flange fitting and a flange which has a flat surface where associate elements penetrate into the pressure vessel through the flange. FIG. 3A shows the flat surface at the end of the flange showing the associate elements penetrating through the flange. FIG. 3B shows the flange fitting and flange together indicated as element 142. The second embodiment is more efficient to fabricate; however, it does include more expensive component parts. FIG. 3C shows a side view of the 3 leg stand 128 for the spherical pressure vessel. FIG. 3D is a bottom view of the 3 leg stand. The second embodiment provides LNG to CNG to NG system and method using the same process as the first embodiment with the following differences to the equipment to accomplish it. First there is added a flange fitting (126) and second there is a flange (127). And all penetrations and associated piping are relocated from the pressure vessel shell to the flange (127). Third, the vessel stand (128) is redefined to 3 leg (128) as opposed to the 4 leg version (122) shown in FIG. 2C and FIG. 2D. The addition of the flange fitting (126) to as shown in FIG. 3 adds uniformity to the production of multiple units of the preferred embodiment. It also results in more expense to accomplish the same process results, adding in the cost of the fitting, the fitting penetration, and the welding of the fitting to the sphere. It also provides a beneficial method to view and repair the internal elements because of the increased size of the flange fitting bore for scoping and robotic repair. The addition of the flange (127) allows the relocation of penetrations to a flat surface instead of the curved sphere surface, and it also allows the relocation of the associated piping to a flat surface. A flange also allows for mistakes to be made and the opportunity to start over without holes in a high pressure vessel. The flange of 127 can precisely locate additional penetrations for the addition of optional refrigeration loops as shown as element 134 in FIG. 8, that require two penetrations more, one in and one out through the flange. The system may also be optionally enhanced by providing a refrigeration thermal exchange loop in and out of the hollow interior (121) of the pressure vessel. The change in the vessel stand (128) shown in FIG. 3C and FIG. 3D being redefined to a 3 leg stand instead of 4 leg stand (122) in FIG. 2C and FIG. 2D is a change based on volume that building 4 vessels at a time taking one leg from each of units one two and three, one has enough legs for unit 4, however the 4th units 2 round plates waste considered the aggregate plate efficiency for a 3 leg stand is 13.6%. This is favorable considering the added benefit of a reduced footprint in shipping width and nesting of multiple 3 leg units together.

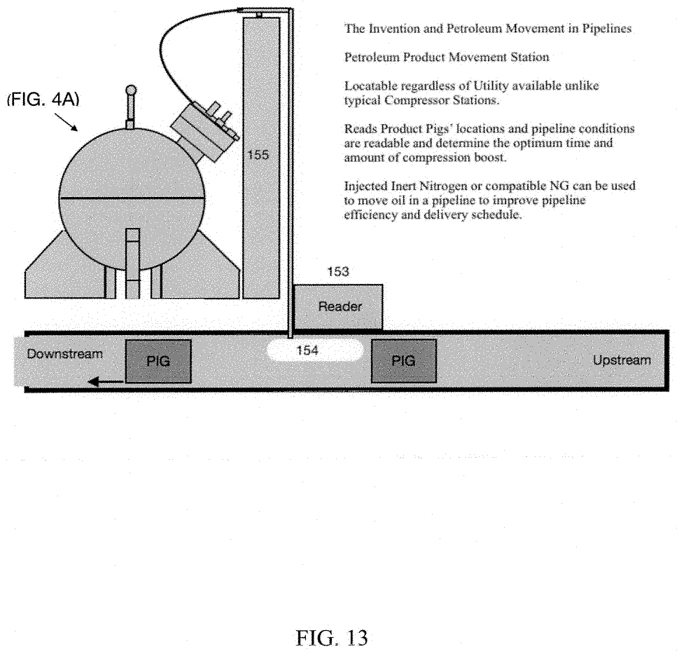

FIG. 4A shows a view of the third embodiment of the invention. The spherical pressure vessel includes a flange fitting and a flange which is connected to a vertical pressure vessel 155. The vertical pressure vessel 155 is used to separate gasses vertically and control the location of the higher density gas. The spherical pressure vessel is shown supported by a 3 leg stand. FIG. 4B shows a flat surface at the end of the flange including the location of associate elements penetrating through the flange. FIG. 4C shows two versions of the interior of the vertical pressure vessel, the first, vertical pressure vessel 143 shows a tube within a tube which delineates a circuitous path as shown. Second, vertical pressure vessel 144 shows a spiral tube variant which may also be used. Both vertical pressure vessels are for the purpose of increasing internal volume for gas storage. They further provide additional conditioning of gas by providing separation between lighter and heavier, potentially wet colder gas to sink and light drier gas to rise and dispense. This embodiment provides enhanced performance with options to enhance performance using different gas conditioning elements. FIG. 4D shows a side view of the 3 leg stand 128 for the spherical pressure vessel. FIG. 4E is a bottom view of the 3 leg stand.

FIG. 5 shows an exploded view of the MPU (Computer Micro-processing Unit) 119. It is a display showing cost, pressures measured, GGE (Gas Gallon Equivalent), the amount of gas used and such. In FIG. 5 the MPU is shown mounted on the flange. The display assists the invention being used in commerce. FIG. 6 shows the first embodiment of the invention being utilized in a maritime environment. On the ocean with the decarbonization of bunker fuel called for in the United States as well as the United Nations there is a strong move for adoption of LNG and natural gas as marine fuels. The present invention is seen as a bridge in the modification of existing marine power plants to natural gas use. The ability of the present invention to produce pressurized air using the cryogen of air as a source, without compressors or electric service will find service in simple pneumatic motors where the exhaust truly is just air. FIG. 7 shows the invention being employed in a mining operation. Underground mines, though there are few, suffer in the degradation of the underground air from overuse. A source of transportation that exhausts clean air with natures mix of oxygen in a mine warrants the invention's use in those conditions. Cryogenic import can be used to change flame temperatures.

FIG. 8 shows the second embodiment of the invention being employed to run a refrigeration/freezer device 135. FIG. 9 shows the third embodiment of the invention being employed to run a standard refrigeration/freezer device 132. Combined with a vented hot water heater, and refrigerator cabinet connected by an absorption refrigerator coil, the invention will provide hot water and fridge by the invention's processed fuel's flame. Using the unique cold attributes of the invention input cryogenic liquid and a method of thermal transfer with the addition of the optional refrigeration loop collecting cold energy at the invention's interior, near the internal dewars container (102), the cold source of the cryogen has a cold value energy enough cold to produce a great number of pounds in ice production each time a cryogen is added, while also beneficially reducing the cycle time it takes to warm and convert the pressurized gas in the process.

FIG. 10 shows multiple detailed views the optional Flange GuardX which may be added to the invention. In addition to esthetics, the Flange GuardX optionally makes it more difficult for mischief (tampering) to occur to a pressure vessel flange. The side view of the top clamshell is shown at (160) and the bottom clamshell at (164). It is assembled in place around a flange fitting and flange depicted here as (163), the flange bolt cover is depicted at (162). Additionally, the use of a tell signal for fugitive leaking is a safety benefit as well as a compliance for the future of flanges. The optional use of chemicals for a tell signal of fugitive emissions holes are depicted at (161).

FIG. 11 shows and describes how a natural gas powered vehicle would employ singly either the first, second or third embodiment of the invention shown in FIG. 2A, FIG. 3 and FIG. 4A respectively by using a valve manifold 145. The use of multiple temperatures of the same gas, also means multiple densities, where the colder densities also contain more gas by weight the method of fueling cooler first and water second will take less time for fueling to occur, which is the inventor's “coolfastfill™” method.

FIG. 12 is a view of the second embodiment of the invention being used to motivate air pressure to move frozen ICE PIGs though a pipeline. In this instance the invention may be used to move ice shapes in a waterline or a pipe used to transport water to scape it clean motivating the ice with pressurized air from the cryogen of air. Alternatively, as shown in FIG. 13 the present invention can be used in remote locations to employ air in the movement of petroleum by increasing the line pressure in areas where utilities are not present.

FIGS. 14A-14D are detailed views showing elements of an LNG personal supply tank device of the present invention which are the origin of the transportable high pressure mobile non dedicated first container, being a “traveling” cryogenic LNG receiving container of the present best invention which may serve to fuel multiple second containers in a single day and deliverable by a pickup truck. FIGS. 14A-14D provide detailed views of an LNG personal supply tank component of the system, history which shows elements of the present invention. This origin of the mobile non dedicated first container as a “traveling” LNG personal supply tank receiving container as evolved provides cryogen for the present best invention. Portable LNG tanks without wheels (less than 15 gallons liquid or weighing about 50 pounds) and portable LNG tanks with wheels (carrying about 50 gallons) in current embodiment has become an integral part of delivery, fueling the phase change and adjusting system of the present LNG to CNG to NG system. This personal LNG tank 330 would be a high pressure container 334 (or 340 or 342) surrounded by insulation 332 (or 338). Appropriate valves 336 and fill/dispense attachments 344 would be utilized to fill the LNG converting gasifier which also retains all, stores all, and dispenses all CNG and NG converted from the LNG from the non dedicated container. Such an element may be a stand alone liquid container for other LNG devices as well and which may serve to fuel multiple second containers in a single day, not dedicated to any specific second container, and which could be deliverable by pickup truck. The feasible elements do exist for this new component of the system. These may be characterized as liquid individual natural gas (LiNG) devices and pressurized liquid individual natural gas (PLiNG) devices. This accessory would be a cryogenic container with an LNG specific input port and output port. It would be constructed with at least one container within a container and further nesting of containers possible. It would preferably be structured with layers of insulation, vacuum layers, and layers of reinforcement.

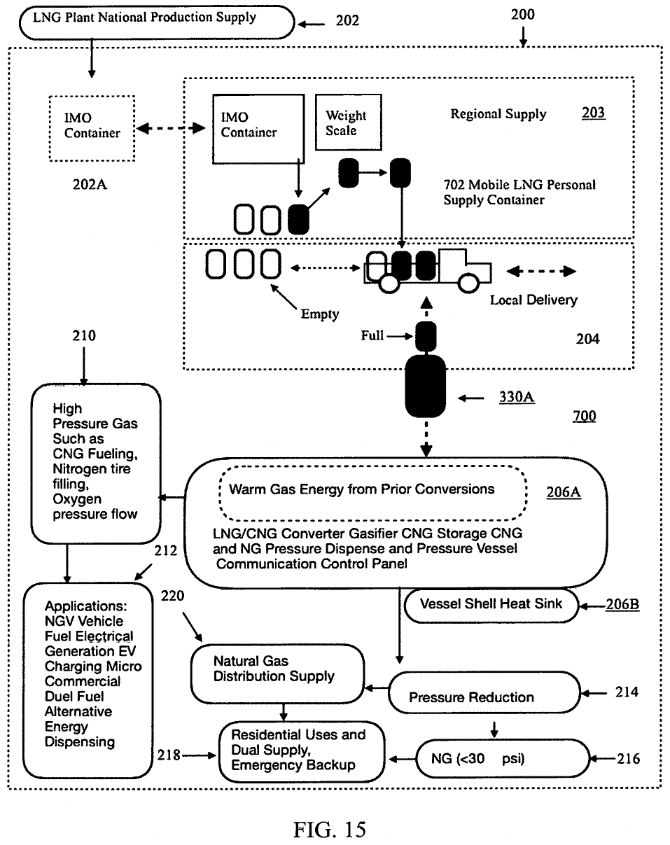

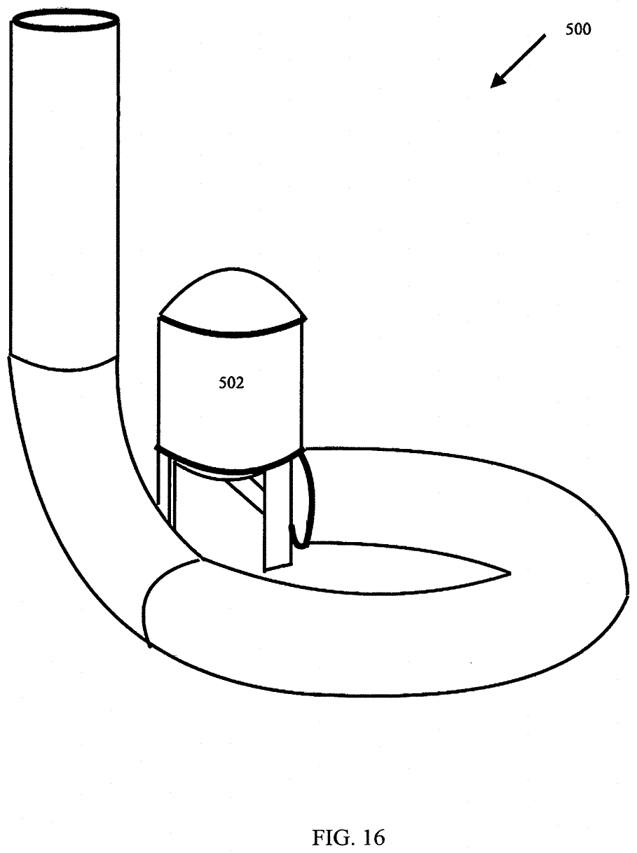

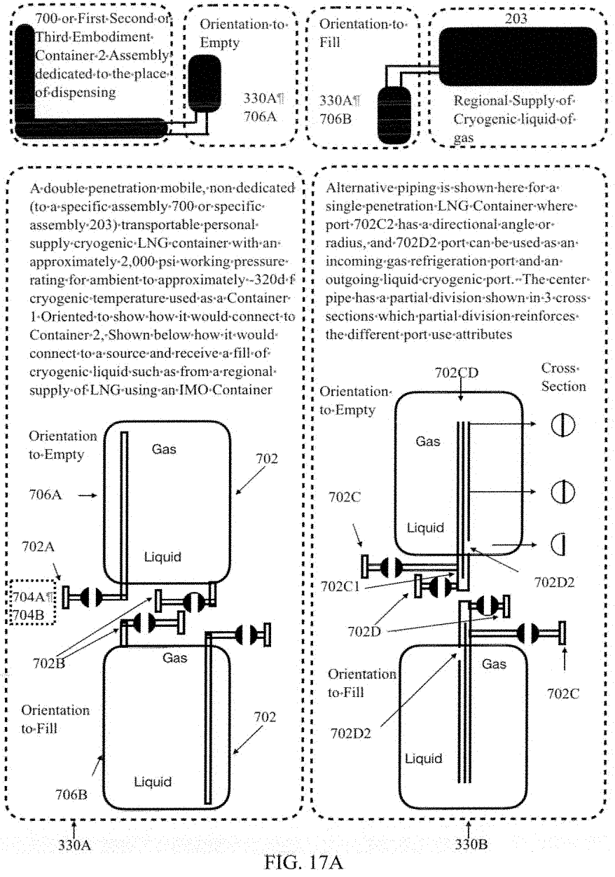

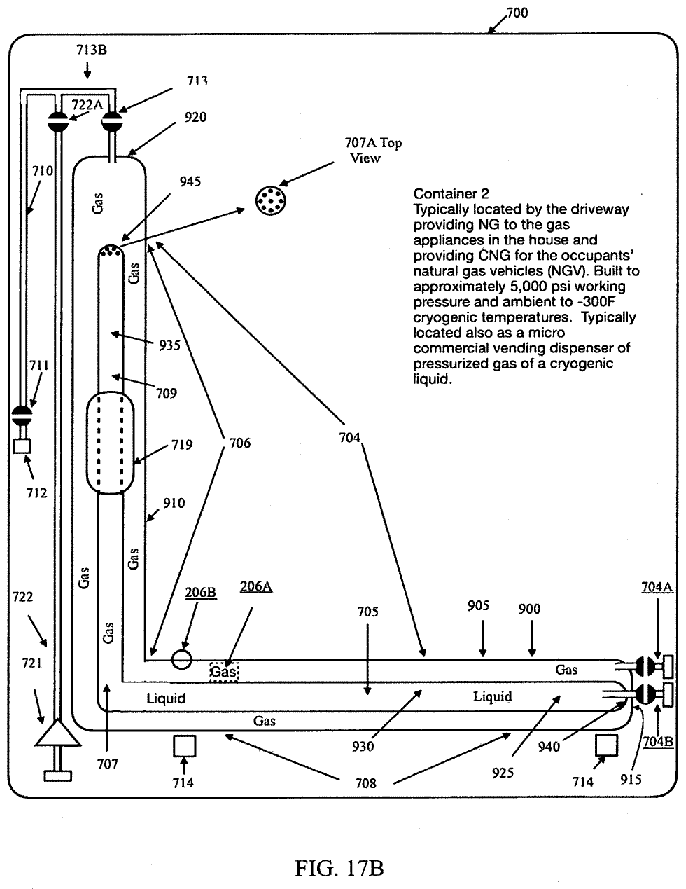

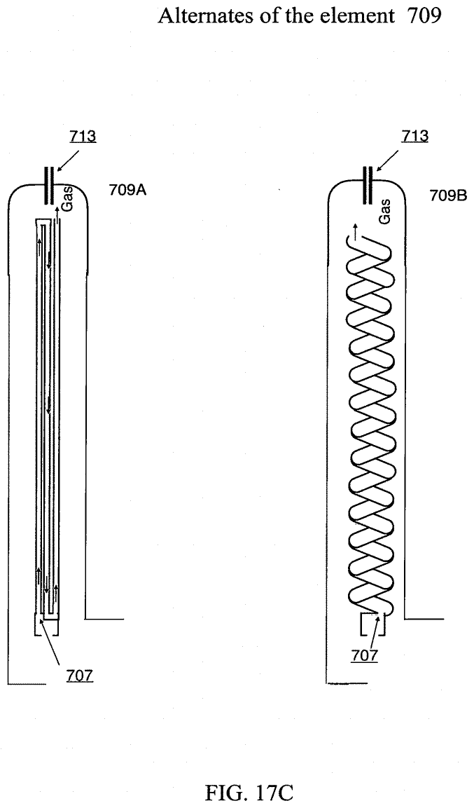

FIG. 15 shows a schematic block diagram of a variety of applications of the present best invention and distribution system of the LNG to CNG to NG system and methods of the present invention. Element 200 shows the assembly of the distribution system of the LNG to CNG to NG and a variety of application uses of preferred cryogen LNG as the best embodiment system and method of the best present invention. LNG is the refrigerated liquid state of methane gas and is an export fuel produced nationally and shown at 202 as an LNG national production supply. An IMO Container 202A is a shipping container which can be used to carry LNG, and be off loaded to establish a Regional Supply Point (RSP). The present best invention fuels the two penetration Mobile LNG Personal Supply Container Assembly 330A, shown in detail at FIG. 17A at the Regional Distribution Supply location 203 the volume of the fill of Container Assembly 330A can be accurately determined by weight scale using a known tare weight of the container. 330A is used for local delivery 204 as the mobile cryogenic personal supply containers which do not require semi trucks for delivery. 330A is the assembly of the container dedicated to the point of dispensing. The two container assemblies can be temporarily connected and cryogenic LNG can be moved from 330A to 700 or to the spherical pressure vessels of the invention. The cryogen of Container Assembly 330A enters into Assembly 700 and is converted to pressurized gas using warm gas energy from prior conversion 206A and using the vessel shell as a heat sink 206B (may weigh about 2 tons) with time and ambient temperature input to complete gasification. At 210 high pressure fueling of the devices of 212 occurs, including a natural gas vehicle at a residence or at a commercial location, in addition the simultaneous micro dispensing of multiple alternative energies of CH4 methane and electric vehicle (EV) recharging using the methane as the energy source for electrical generation will occur. At 216 low pressure NG is produced by pressure reduction of high pressure gas at 214. Any and all of the production supply may be set aside and saved 218, reserved for a future emergency or put to current use; or if natural gas, could become a part of a natural gas.

FIG. 16 shows an additional embodiment of the invention showing elements of horizontal and vertical orientation and elevation difference to accomplish gravity flow of the LNG receiver and the phase change container structure. This is but one implementation of any number of possible structures. FIG. 16 shows element (500) shows the use of the static cryogenic container (502) within the structure of the gasification process container and capable of pressures in excess of approximately 5,000 psi. Operation of the structure of the prior system shown in FIG. 16 is similar to that shown in FIGS. 17A and 16B except that the cryogenic container is not mobile. The gravity feed structure of the embodiment shown in FIG. 7 eliminates the need to balance gas pressure to flow the LNG into the internal dewars container as this is now accomplished by gravity feed and the integrity of the non-mobile structure. This system lends itself to implementation in smaller (lower quantities) environments such as residential homes, small industrial applications, and the like, such as micro commercial gas dispensing applications.

FIG. 17A shows the container structure of the two penetration non dedicated transportable personal supply cryogenic container used as the cryogenic supply container of the system of the present best invention, as well as an alternate piping single penetration version and detail on container orientation to fill and to empty and interaction between other containers in the system and process. Optionally, a single penetration non dedicated transportable personal supply cryogenic container is presented. FIG. 17A discloses in partially schematic form the basic structure of the system of the invention mobile personal supply cryogenic comprised in Container 1 as a non-dedicated portable mobile two penetration personal supply container and said first container (702) is comprised of a 50 gallon liquid volume and approximately 2,000 psi at −300 F. Work pressure cryogenic vessel can be used in conjunction with a Container 2 although not dedicated to a specific Container 2. Container 2 is where primary cryogenic conversion occurs from liquid to gas, product retention, and high pressure storage, and dispensing at the will of a human occurs. FIG. 17A further shows the container structure as 330A assembly, as well as an alternate piping single penetration assembly of 330B. Different container orientations to fill and to empty are also shown at the lower portion of FIG. 17A. Container 1, element 702, is approximately 50% of the size of the Container 2 of Assembly 700 being fueled. This scale ratio is based on the goal pressure and the expansion ratio of the cryogenic molecule when it converts to gas and is fully retained to not require forced dispensing. To fill Container 1 it is positioned at the 706B orientation and connected to an IMO container 202A as shown in FIG. 15, or some other source of cryogen supply. It can be filled from the bottom up entering cryogenic liquid through deep port, valve and pipe 702A. It can also be filled from the top down by permitting the liquid entering through the flush port valve and pipe 702B. 702A and 702B are two way ports for cryogenic liquid or for gas. In FIG. 8A valves are identified as a black filled circle with a “path”. To empty Container 1, it is positioned at the 706A orientation and at an elevation above a Container 2, and temporarily connected to such as a Container 2 process Container Assembly 700 or the sphere as shown in FIGS. 4A-4E, and FIG. 17A in dashed lines where 702B is connected to 704B and 702A is connected to 704A. Elements 704A and 704B are two way ports for gas, and 704B is also a two way port for liquid. To transfer liquid out of Container 1 into a Container 2, a balance of pressure must be first attained between the containers opening the valve associated with 702A and 704A. Upon pressure balance the valves 702B and 704B are then opened and liquid will gravity flow into the Container 2 of Assembly 700 or either the first embodiment, the second embodiment or the third embodiment of the invention. After this operation process Container 702 of Assembly 330A can further be used to dispense residual gas at 702A deep port or 702B flush port. Internal gas can be refrigerated to increase density or reliquify by adding cryogen of the gas to any gas in the refilling of the Container 702 initially through flush port 702B, then completing the fill through deep port 702A. Container 1 is mobile, easily transportable and not dedicated to a specific Container 2. Optionally a single penetration non dedicated transportable personal supply cryogenic container is presented as assembly 330B. The primary gas port and deep port 702C which enters the container with a directional radius and single penetration is shown at 702C1. The primary liquid single penetration flush port is also shown as number 702D, providing a flush opening of a deep port to the container empty at 702D2. The internal port is partially divided as seen in the cross sections to the right of container in FIG. 17A. 702CD cross sections represent the partial division of the deep port of the single penetration container. A single penetration container anticipates the benefit of cost and reliability over the two penetration container. However, for the benefit of variable control and redundancy the present best invention uses the two penetration container, but some preference for the one penetration container for cost benefit in certain instance is present. Still referring to 17A, a double penetration, mobile, transportable, personal supply cryogenic first LNG container 330A is provided. First LNG container 330A is filled from a regional LNG supply 203. Here the first container 330A is filled with LNG until the first container has conditions of approximately 2,000 psi working pressure rating for ambient to approximately −300 degrees F. When the first container 330A is being filled with LNG at regional LNG supply 203, it is oriented as shown in FIG. 17A, element 706B. This shows the first container 330A in position to be filled by IMO Container or the like 203. The first container 330A is then taken by transport to a second LNG container 700 or the pressure sphere of the first embodiment, the second embodiment, or the third embodiment of the invention, any which may be placed proximal a house, living quarters, trailer, or mobile home, where the second container 700 is inter-fit with connecting elements of first container 330A. Note the orientation of the first container as shown in FIG. 17A, element 706A. FIG. 17A also shows alternative piping for a single penetration LNG container which is shown at 330B.

FIG. 17B shows the container structure of the dedicated converter gasifier which can retain all converted gas from a cryogen and dispense in multiple pressures, and is the container of the present best invention of the system, and dispenses only at the demand of a human operator and can be delivered, transported, assembled complete using a pickup truck and trailer, and when after placed at the location of dispensing, can receive cryogenic liquid from the container shown in 17A. It how the invention which changes the state of a cryogenic liquid to a pressurized gas and permits the dispensing of a multi pressure gas supply system. Located in box 700 is the assembly of the second container 704 and having vertical 706 and horizontal 708 elements supported by legs 714, and scaled approximately two times larger than the cryogen supply to retain all converted gas from a cryogen, and dispense in multiple pressures from the container. This ratio defines that the dedicated cryogenic converter gasifier as larger than the Cryogenic supply by 200%-240% percent for LNG to result in useful pressures of about 3,500-5,000 psi in an LNG to CNG conversion using this best invention. For small scale residential customers container 704 will have a 96 gallon liquid volume and will be capable of a 5,000 psi work pressure vessel and be rated for temperatures as low as approximately −300 F. In addition to LNG methane natural gas, this best present invention and this container when scaled properly using the expansion conversion ratios of other cryogens is also capable of the conversion of Argon, Nitrogen, and Oxygen converted from their cryogenic liquid to gas form. These elements with the invention would find dispensing use in manufacturing of windows, smelting of metals, and as additives for altering flame characteristics, inflating pneumatic tires, and in the health care industry. In each cryogen of a gas listed above, the dedicated container will be larger than the supply container by at least double; the ratio difference is determined by the rate of expansion from the liquid state to the gas state of each cryogen, adjusting mathematically container ratios for the target dispensing pressure. When being installed at the dedicated location for dispensing, Assembly 700 can be transported assembled complete using a pickup truck and trailer to the desired dispensing location, and is capable of attaining a pressure balance to receive cryogenic liquid from either of the containers in FIG. 17A. The horizontal portion 708 of Container 704 has two ports 704A and 704B. Element 704B port, pipe, and valve is an in and out port for gas and an in and out port for cryogenic liquid, and is connected to the horizontal internal isolation container 705. Element 704A, port, pipe, and valve is an in and out gas port between the inside isolation container 705 and the inside of the container 704. 704A and 704B are also entrance ports for enhanced performance additives for gases of cryogenic liquids and dispense when the main product dispenses such as additives that change flame characteristics of LNG. This results in the operation of the structure such that the cryogenic liquid LNG can enter through the port and pipe at 704B into the horizontal partial cryogenic containment element at 705 by gravity feed after balancing the pressure of Container 2 with a Container 1. Thereafter cryogenic liquid can be converted to a pressurized gas by the warm gas 206A thermal equalization of temperature from previous retained gasifications and heat radiated from the shell of Container 704 shown at 206B after time and absorbing ambient temperature. Heating the cryogenic liquid inside horizontal internal isolation container of 705, it expands and rises through the transition port 707 upward through the internal vertical partial isolation container of 709. Losing the liquid state, it rises through the opening into the inside of vessel at 707A to be ready to dispense. It leaves container through the vertical element at port and valve 713 and through pipe 713B and can be dispensed as gas at a point in time desired by the direction of the human dispenser operator who has a multiple choice of desired pressures including through a high pressure pipe 710 and dispensing valve 711, and CNG dispensing fixture 712 and lower pressure through valve 722A and first pipe 722 and through pressure reducing valve 721 or to choose not to dispense but to save for the future. The control and instrumentation location, including communication, is at 719, and at a corresponding communication location the Regional Supply machine to machine communication will result in a notice of the need to fill a dispenser and define the fill volume, and the dispensing location, as well as the route for Local Delivery using digital communication known in the art so is not discussed in greater detail. To recap, FIG. 17B shows Container 2 as element 704, which is transportable, and may be pre-assembled for delivery to a single residence. Once delivered to the residence Container 2 rests on elements 714 and is designed to remain at the residence and to be refilled at the residence. Container 2 704 may be considered an LNG and NG reservoir, gasifier and dispenser for a residence, which may be transported to a residence using a pickup truck, van, small truck or other small transport devices. The invention may be pulled on a flatbed trailer.

FIG. 17C shows two alternates of the vertical internal partial container element 709 of FIG. 17B for the physical promotion of separation of liquid and gas in conversion or gasification of cryogenic liquid to gas where it can be made to more actively separate the gas from the liquid in phase conversion using a gas density weight and differential physical force to aid separation by directing the stream of converting gasifying liquids leaving the horizontal containment through the transition port of 707 into the vertical element onto a forced path such as a circular climbing shown as 709B or such as falling and rising back and forth such as shown as 709A, either method of which physically separates gas from liquids for the benefit of product dispensing. The sphere shaped pressure vessel of the third embodiment of the invention shown in FIG. 4A with the vertical pressure vessel (143 or 144) shown in FIG. 4C uses a modified version of the concept of FIG. 17C and may be considered analogous to elements 709A and 709B of FIG. 17C.

Although the present invention has been described in conjunction with a number of embodiments, those skilled in the art will recognize modifications to these embodiments that still fall within the scope of the present invention. Alternately, the present invention may be implemented in conjunction with electrolysis at depth and/or pressure. Alternate embodiments in conjunction with differently sized systems are also anticipated.

### TABLE OF PARTS

101 Sphere shaped pressure vessel of a material to sustain high pressure and cryogenic temperature such as 304 stainless steel.
102 Internal dewars container to sustain cryogenic temperatures such as 304 stainless steel.
103 Stand for internal dewars container (102) of a material compatible with the pressure vessel (101).
104 Scallop openings for the stand (103) to allow gas to move uninhibited.
105 Sensors of the environment in the hollow interior (121).
106 Penetration and pipe for sensors and leads of sensors to be closed secure after leads and sensors installed.
107 Low pressure pipe exit which may be valved or capped close.
108 High pressure to low pressure reducer, a low pressure through valve (LPTV).
109 Two way (in out off) valved high pressure pipe exit.
110 Four way high pressure branch in and out for charging and a low and a high pressure feed, which could be further branched.
111 High pressure pipe exit, which may be valved.
112 One way in valved cryogenic liquid portal penetration and associated pipe.
113 Gas left over from previous processes which may by weight be 20- to more than 40% of the capacity of hollow interior (121). Gas from previous input, which following Gas principles is absorbed by the incoming cryogen of that same gas and commence gasification.
114 Square drive for attaching a temporary gear for fabrication or site set up of equipment.
115 Lifting ball and pipe for positioning, and gaged to safely lift all of the unit.
116 Flexible pole support bendable to move but stiff enough to hold the hose off the ground which may also have dual use as a lightning rod.
117 Flexible high pressure hose, rated to carry the pressures and chemistry of the gasses proposed.
118 Quick connect high pressure nozzle chemistry rated to dispense a maximum uniform pressure by industry associations.
119 Micro processor unit with screen programmable for specific requirements.
120 Drive gear for square drive (114) for a belt or chain.
121 Hollow interior to determine volume value in cubic feet or by gallons.
122 Four leg pressure vessel stand to obtain high retention of the same chemistry of metal for
efficiency of use and recycling; however the footprint in shipping is inferior, and nesting of multiple units, and the opportunity of failure is greater than with a 3 leg pressure vessel stand.
124 Communication lead wires which connect to sensors (105) and MPU (119).
125 Horizontal weld seam for pressure vessel, is a designed engineered weld. Those in the art will recognize that there will be additional common equipment such as drain valves, and pressure relief valves, ground wire and stakes, cathode protections, paint, and coatings needed or required by governmental, and business requirements and not depicted herein as they are common to all
vessels and only serve to add volume and not substance to the description of the inventive embodiments.
126 Flange fitting integrates a nozzle and the lower flange.
127 Flange is a blank to be customer drilled for penetration location, which if prepared improperly can easily be replaced which is an advantage over mistakes in drilling the rounded surface of a pressure vessel.
128 Three leg pressure vessel stand is preferred if 3 or more vessels are made at a time, allowing each 4th vessel to be supplied by one legs of each of the three previous plates where the
waste was about 11% each plate but it is not as efficient as a 4 leg stand because of the 21.5% waste on the 4th plate, and the aggregate plate efficiency for a 3 leg stand is 13.6%.
129 Low pressure gas distribution, a distribution serving multiple existing manufactured cornbustable gas products such as stoves and heaters.
130 Hot water heater serving two purposes, using pressurized combustible gas from the invention to heat water, and providing a means to cover an open flame used in absorption refrigerators, and safely vent it.
131 Pilot light serving two purposes, using pressurized combustible gas from the invention, and giving up energy for heating water, and motivating a refrigeration coil.
132 Refrigerator/freezer cabinet for efficiently retaining cold from the invention.
133 Absorption refrigeration coil motivated by a flame of a gas of a cryogen converted by the invention.
134 Thermal transfer refrigeration loop capturing latent cold of a cryogen in the invention.
135 Freezer cabinet.
136 (FIG. 6.) Work boat of US flag controlled by the US Coast Guard and able to go from US port to US port.
137 Natural gas marine engine, is available in crate or convertible from some bunker diesel versions.
138 (FIG. 7) Pneumatic filling valve, to a storage of pressurized air (FIG. 7).
139 Air whistle for safety and exhaust of pneumatics.
140 Pneumatic drive system is basically an air piston driven by air pressure.
141 More pull carts.
142 Flange fitting and flange together show the difference between First preferred embodiment and the Second preferred embodiment.
143 Vertical pressure vessel gas conditioning of a tube within a tube within a tube option where the up and down repetition that the gas is required to follow serves to homogenize the gas stream prior to exiting.
144 Vertical pressure vessel gas spiral climb gas conditioning option, where centrifugal force as any wet gas is present, is pushed up against a surface, ideally smooth, sticks and condenses until it gasifies.
155 Vertical pressure vessel used to separate the gases vertically and control the location of the higher density gas.
156 Vertical vessel gas input point and valve.
157 Vertical vessel gas output point and valve, positioned on top to use the lightest gas within the container.
158 Hot water heater vent.
   FIG. 10 shows detailed views the optional Flange GuardX for the embodiments of the Second Embodiment and the Third Embodiment to be installed for the purpose of protecting agaMst vandalism of fittings and nuts and bolts used with a Flange Fitting and Flange.
159 Underground, absent a surrounding atmosphere (FIG. 7).
160 The side view of the top clamshell of GuardX.
161 Optional use of chemicals for a tell signal of fugitive emissions holes are depicted for this option.

The following details which part is in which figure number:

FIG. 1A Cutment Plate Pattern, steel plate pattern for cutting numbers 1-4 show relationship of the plate to the stand and vessel
FIG. 1B-cutaway showing internal and external elements and plate relationship
FIG. 1C perspective view shows bottom pressure vessel head 4 leg stand penetration relationship with interior, in only cryogenic valve pipe, two way gas pipe, sensor and leads pipe
FIG. 1D, FIG. 2A, FIG. 2B. perspective view shows top head, lifting (115) MPU with leads and high gas pipe (109) and cryogenic one way valve penetration and associated pipe (112) and temporary drive gear (120) for fabrication and installation

FIG. 2A, FIG. 2B. FIG. 2C, FIG. 2D, the First preferred embodiment

The First preferred embodiment is the ambient heat sink of the weight of the materials of this embodiment and the current outside environmental conditions
101 FIG. 2A sphere shaped pressure vessel of a material to sustain high pressure and cryogenic temperature such as 304 stainless steel
102 FIG. 2B internal dewars container to sustain cryogenic temperatures such as 304 stainless steel
103 FIG. 2B stand for internal dewars container (102) of a material compatible with the pressure vessel (101)
104 FIG. 2B scallop openings for the stand (103) to allow gas to move uninhibited
105 FIG. 2B sensors of the environment in the hollow interior (121
106 FIG. 2A penetration and pipe for sensors and leads of sensors to be closed secure after leads and sensors installed
107 FIG. 2A low pressure pipe exit which may be valved or capped close
108 FIG. 2A high pressure to low pressure reducer, a low pressure through valve (LPTV)
109 FIG. 2A two way (in out off) valved high pressure pipe exit
110 FIG. 2B 4 way high pressure branch in and out for charging and a low and a high pressure feed, which could be further branched
111 FIG. 2A high pressure pipe exit, which may be valved
112 FIG. 2B one way in valved cryogenic liquid portal penetration and associated pipe
113 FIG. 2B gas left over from previous processes which may by weight be 20- to more than 40% of the capacity of hollow interior (121). Gas from previous input, which following Gas principles is absorbed by the incoming cryogen of that same gas and commence gasification
114 FIG. 2A square drive for attaching a temporary gear for fabrication or site set up of equipment
115 FIG. 2A lifting ball and pipe for positioning, and gaged to safely lift all of the unit
116 FIG. 2A flexible pole support bendable to move but stiff enough to hold the hose off the ground which may also have dual use as a lightning rod
117 FIG. 2A flexible high pressure hose, rated to carry the pressures and chemistry of the gasses proposed
118 FIG. 2A quick connect high pressure nozzle chemistry rated to dispense a maximum uniform pressure by industry associations
119 FIG. 2B micro processor unit with screen programmable for specific requirements
120 FIG. 2A drive gear for square drive (114) for a belt or chain
121 FIG. 2B hollow interior to determine volume value in cubic feet or by gallons
122 FIG. 2D 4 leg pressure vessel stand to obtain high retention of the same chemistry of metal for efficiency of use and recycling; however the footprint in shipping is inferior, and nesting of multiple units, and the opportunity of failure is greater than with a 3 leg pressure vessel stand
124 FIG. 2B communication lead wires which connect to sensors (105) and MPU (119)
125 FIG. 2A horizontal weld seam for pressure vessel, is a designed engineered weld
Those in the art will recognize that there will be additional common equipment such as drain valves, and pressure relief valves, ground wire and stakes, cathode protections, paint, and coatings needed or required by governmental, and business requirements and not depicted herein as they are common to all vessels and only serve to add volume and not substance to the description of the inventive embodiments.

FIG. 3, FIG. 3A, FIG. 3B. FIG. 3C,FIG. 3D the Second preferred embodiment

The Second preferred embodiment is the ambient heat sink of the weight of the materials of this embodiment and the current outside environmental conditions
126 FIG. 3 flange fitting integrates a nozzle and the lower flange
127 FIG. 3A flange is a blank to be customer drilled for penetration location, which if prepared improperly can easily be replaced which is an advantage over mistakes in drilling the rounded surface of a pressure vessel
128 FIG. 3A-D 3 leg pressure vessel stand is preferred if 3 or more vessels are made at a time, allowing each 4th vessel to be supplied by one legs of each of the three previous plates where the waste was about 11% each plate but it is not as efficient as a 4 leg stand because of the 21.5% waste on the 4th plate, and the aggregate plate efficiency for a 3 leg stand is 13.6%
142 flange fitting and flange together show the difference between First preferred embodiment FIG. 2A,FIG. 2B. FIG. 2C,FIG. 2D. and the Second preferred embodiment FIG. 3, FIG. 3A, FIG. 3B. FIG. 3C, FIG. 3D.
Those in the art will recognize that there will be additional common equipment such as drain valves, and pressure relief valves, ground wire and stakes, cathode protections, paint, and coatings needed or required by governmental, and business requirements and not depicted herein as they are common to all vessels and only serve to add volume and not substance to the description of the inventive embodiments.

FIG. 4A, FIG. 4B FIG. 4C, FIG. 4D. FIG. 4E—The Third preferred embodiment Third preferred embodiment is the ambient heat sink of the weight of the materials of this embodiment and the current outside environmental conditions

143 FIG. 4C vertical pressure vessel gas conditioning of a tube within a tube within a tube option where the up and down repetition that the gas is required to follow serves to homogenize the gas stream prior to exiting
144 FIG. 4C vertical pressure vessel gas spiral climb gas conditioning option, where centrifugal force as any wet gas is present, is pushed up against a surface, ideally smooth, sticks and condenses until it gasifies
155 FIG. 4A vertical pressure vessel used to separate the gases vertically and control the location of the higher density gas
156 FIG. 4C vertical vessel gas input point and valve
157 FIG. 4A vertical vessel gas output point and valve, positioned on top to use the lightest gas within the container
Those in the art will recognize that there will be additional common equipment such as drain valves, and pressure relief valves, ground wire and stakes, cathode protections, paint, and coatings needed or required by governmental, and business requirements and not depicted herein as they are common to all vessels and only serve to add volume and not substance to the description of the inventive embodiments

FIG. 5, FIG. 6, FIG. 7

119 FIG. 5 MPU display showing commerce in two gas pressures
136 FIG. 6 work boat of US flag controlled by the US Coast Guard and able to go from US port to US port
137 FIG. 6 natural gas marine engine, is available in crate or convertible from some bunker diesel versions
138 FIG. 7 pneumatic filling valve, to a storage of pressurized air
139 FIG. 7 air whistle for safety and exhaust of pneumatics
140 FIG. 7 pneumatic drive system is basically an air piston driven by air pressure
141 FIG. 7 more pull carts
159 FIG. 7 underground, absent a surrounding atmosphere

FIG. 8, FIG. 9

129 FIG. 9 low pressure gas distribution, a distribution serving multiple existing manufactured combustable gas products such as stoves and heaters
130 FIG. 9 hot water heater serving two purposes, using pressurized combustible gas from the invention to heat water, and providing a means to cover an open flame used in absorption refrigerators, and safely vent it
131 FIG. 9 pilot light serving two purposes, using pressurized combustible gas from the invention, and giving up energy for heating water, and motivating a refrigeration coil
132 FIG. 9 refrigerator/freezer cabinet for efficiently retaining cold from the invention
133 FIG. 9 absorption refrigeration coil motivated by a flame of a gas of a cryogen converted by the invention
134 FIG. 8 thermal transfer refrigeration loop capturing latent cold of a cryogen in the invention
135 FIG. 9 freezer cabinet
158 FIG. 9 hot water heater vent

FIG. 10 shows detailed views the optional Flange GuardX for the embodiments of the Second Embodiment and—the Third Embodiment to be installed for the purpose of protecting against vandalism of fittings and nuts and bolts used with a Flange Fitting and Flange

(160) The side view of the top clamshell
(161) shows optional use of chemicals for a tell signal of fugitive emissions holes are depicted
(162) depicts the flange bolt cover
(163) shows a typical flange fitting and flange
(164) shows a matching side view of (160) of the bottom clamshell

FIG. 11

145 manifold with valves for fueling one natural gas vehicle, using multiples of the invention
146 CNG natural gas vehicle to be filled by multiple of the invention.

FIG. 12, FIG. 13

147-150 FIG. 12 ice shapes for cleaning water pipelines, made by the invention, pushed through the waterlines by the pressurized gas of the invention.
151 FIG. 12 quick connect receiver for putting pressurized air in a waterline to move an ice shape
152 FIG. 12 ice shape loading point
153 FIG. 13 is the reader to sense pipeline PIG and temperature and pressure to determine the volume of pressurized input of gas from the intention
154 FIG. 13 in an injection of pressurized gas from the invention to move petroleum by increase of pressure.

Although the present invention has been described in conjunction with a number of embodiments, those skilled in the art will recognize modifications to these embodiments that still fall within the scope of the present invention. Alternately, the present invention may be implemented in conjunction with electrolysis at depth and/or pressure. Alternate embodiments in conjunction with differently sized systems are also anticipated.

I claim:

1-18. (canceled)

19. The LNG cryogenic liquid of a gas reservoir, gasifier and high pressure natural gas and low pressure natural as pressurized gas dispenser as a means to supply gas, and comprised of: the external sphere shape pressure vessel (101) and the 4 leg sphere vessel stand (122) for conservation and recycle centric purposes and to preserve a thermal mass of the same plate material as the pressure vessel plate pattern (FIG. 1A), and centered on top of the vessel is the post and larger diameter ball (115) for lifting and positioning, and gaged to support more than the weight of the sphere to lift and carry all (FIG. 2A) safely and also between the lifting ball (115) and sphere shaped vessel (101) is the square drive point (114) capable to receive a temporary drive gear (120) as an aid in rotational location during fabrication such as automated welding and bevel cutting of the centered circumference weld seam (125) and usable for installation of the present invention and, further the sphere pressure vessel (101) is divided into vertical and horizontal planes for the location of components beginning at the bottom quarter centered horizontally within the hollow interior (121) is located the stand (103) at its lowest horizontal plane is affixed to the inside shell of the pressure vessel and where it adjoins it has a repetition number of scallop shaped voids (104) to allow movement of gas to move vertically and horizontally under and out from under the stand (103) and in the middle one half of the sphere pressure vessel hollow center (121) there is located the internal Dewar Container (102), and its bottom is attached to the top of the stand (103) and its sides rise vertically to a point to obtain its predetermined volume, and is open at the top and positioned under certain penetrations and not under certain other penetrations, the internal Dewar Container (102) is the means for receiving cryogenic liquid and protecting the external pressure vessel shell from thermal shock of cryogenic liquid temperatures, and its volume calculation is sized approximately 1:2.4, the size of the internal volume of the sphere pressure vessel's hollow interior (121) (when the Cryogen being used is LNG and the design pressure of the vessel is 5,000 psi), and further, located in the upper quarter of the sphere are three penetrations through the sphere, and three corresponding pipes, and the largest penetration through the external sphere shaped pressure vessel (101) the cryogenic penetration and its corresponding pipe (112) is attached to a one way valve (in only) and terminates inside the diameter of the vertical axis of the internal Dewar Container (102) for the purpose to cause cryogenic liquid from the outside to be directed into the internal Dewar Container (102) where cryogenic liquid warms to gas commingling with adjacent warm gases (113) previous introduced into the pressure vessel, and then further, located through the upper quarter portion of the horizontal plane of the sphere the second largest penetration is a gas penetration and its corresponding piping (109) through the external sphere shaped vessel (101) to allow movements of pressurized gas both in and out of the hollow interior (121) and outside of the diameter of the vertical axis of the internal Dewar Container (102) with the corresponding pipe neither directed into or out from the internal Dewar Container (102), the gas penetration and corresponding pipe (109) is used to balance pressure in and out between the pressure vessel (101) and a cryogenic supply prior to receiving a cryogen from the supply, as pressures must equalize before liquids may move from the outside in, following Gas Law, and when a cryogen is added to the Dewar Container (102) with time the ambient temperature gas and the cryogen liquid commingle to equilibrium temperature and density, proportionate to their relative weight in the hollow interior (121) and, in addition, within and surrounding the hollow interior (121) is a thermal mass heat sink the size of the weight of materials of the embodiment (FIG. 2A) multiplied by the ambient temperature warms the smaller gas product weight of the cryogen already in the process of warming, and additionally there is one more penetration, the smallest and its corresponding pipe (106) through the external sphere (101) located in the upper quarter of the horizontal plane of the sphere shaped pressure vessel located outside the diameter of the vertical axis of the Dewa Container (102) to bring in sensors (105) connected to communication lead wires (124) prior to adding any gas or cryogen to the present invention, these sensors (105) are for measuring the condition of the interior environment of the present invention embodiment, including such as temperature, pressure and the like, and to furthermore aid in calculations, and the leads from the sensors providing signals connect to a Micro Processor Unit (119) outside the pressure vessel (101) for the purpose of communication, commerce and service calculations and will likely interface with users cell phones and furthermore additionally, the gas penetration and corresponding pipe (109) has branches to provide high pressure gas for use on demand from pipe (111) additionally to serve more markets and usability; it branches also to allow pressure reduction step down using a low pressure through valve LPTV (108) and dispenses at (107) the low pressure gas where it will likely merge into a typical gas distribution pipeline, also the higher energy density high pressure gas dispensing for high pressure gas quick connect (118) for filling high pressure gas tanks efficiently using a flexible hose (117) connected to a less flexible supporting pole (116) which serves to keep the hose clean and off the ground.

20. The Invention of claim 19, The LNG cryogenic liquid of a gas reservoir, gasifier and high pressure natural gas and pressurized gas dispenser as claimed in claim 19 and where the sphere shape pressure vessel (101) and stand (FIG. 1B) are made from the material of a single plate (FIG. 1A) efficiently and resulting waste is less than 11% of the weight of that plate.

21. The Invention of claim 19, The LNG cryogenic liquid of a gas reservoir, gasifier and high pressure natural gas and low pressure natural gas pressurized gas dispenser as claimed in claim 19 and where the cryogen is LN (Liquid Nitrogen) and the resulting gas is pressurized Nitrogen.

22. The Invention of claim 19, The LNG cryogenic liquid of a gas reservoir, gasifier and high pressure natural gas and low pressure natural gas pressurized gas dispenser as claimed in claim 19 and where the cryogen is the gases of the air liquified as the cryogen and the resulting gas is pressurized air and is located on a mobile platform that may be at times used underground (159 FIG. 7) to power the platform by pneumatics (140) and being the source of noncombustible gas and potentially air to humans who may be underground.

23. The Invention of claim 19, The LNG cryogenic liquid of a gas reservoir, gasifier and high pressure natural gas and low pressure natural gas pressurized gas dispenser as claimed in claim 19 and where the cryogen is the gases of the air liquified as the cryogen and the resulting gas is pressurized air.

24. The Invention of claim 19, The LNG cryogenic liquid of a gas reservoir, gasifier and high pressure natural gas and low pressure natural gas pressurized gas dispenser as claimed in claim 19 and where it is used as the fuel supply container for a mobile platform such as a boat (136 FIG. 6) and providing natural gas to the platform; it is the source of combustible gas to run its engine (137 FIG. 6).

25. The LNG cryogenic liquid of a gas reservoir, gasifier and high pressure natural gas and low pressure natural as pressurized gas dispenser (FIG. 3) as a means to supply gas, and comprised of: the external sphere shape pressure vessel (101) and the 3 leg sphere vessel stand (128 FIG. 3C, FIG. 3D) for conservation and to preserve a thermal mass of the same plate material as the pressure vessel plate pattern (FIG. 1A) for 3 of the 4 leg sections shown, and centered on top of the vessel is the post and larger diameter ball (115) for lifting and positioning, and gaged to support more than the weight of the sphere to lift and carry all (FIG. 2A, 3) safely and also between the lifting ball (115) and sphere shaped vessel (101) is the square drive point (114) capable to receive a temporary drive gear (120 FIG. 2A, 2B, 3) as an aid in rotational location during fabrication such as automated welding and bevel cutting of the centered circumference weld seam (125) and usable for installation of the present invention, and further the sphere pressure vessel (100 is divided into vertical and horizontal planes for the location of components and in the upper quarter of the pressure vessel sphere (101) there is a penetration at an angle off the vertical axis of the sphere pressure vessel (101) for the fitting penetration and inclusion of the Flange Fitting (126) and Flange (127), and at the bottom quarter centered horizontally within the hollow interior (121 FIG. 2B) is located the stand (103 FIG. 2B) at its lowest horizontal plane, is affixed to the inside shell of the pressure vessel and where it adjoins it has a repetition number of scallop shaped voids (104 FIG. 2B) to allow movement of gas to move vertically and horizontally under and out from under the stand (103) and in the middle one half of the sphere pressure vessel hollow center (121) there is located the internal Dewar Container (102 FIG. 2B), and its bottom is attached to the top of the stand (103) and its sides rise vertically to a point to obtain its predetermined volume, its open top positioned in line with where certain penetrations through the Flange (127 FIG. 8) and corresponding pipes will be located and not in line with where other certain penetrations corresponding pipes will be located, as the internal Dewar Container (102 FIG. 8) is the means for receiving cryogenic liquid and protecting the external pressure vessel shell (101) from thermal shock of cryogenic liquid temperatures, and its volume calculation is sized approximately 1:2.4, the size of the internal volume of the sphere pressure vessel's hollow interior (121) (when the Cryogen being used is LNG and the design pressure of the vessel is 5,000 psi), and further, there are located three penetrations through the Flange (127 FIG. 8), and three corresponding pipes, and the largest penetration through, the Flange (127) and its one way in valve and corresponding pipe (112) is attached at its outermost point and its innermost point terminates inside the diameter of the vertical axis of the internal Dewar Container (102 FIG. 2B, 8) for the purpose to cause cryogenic liquid from the outside to be directed into the internal Dewar Container (102) where cryogenic liquid warms to gas commingling with adjacent warm gases (113) previously introduced into the pressure vessel, and the second largest penetration located through the upper quarter portion of the horizontal plane of the sphere is the gas penetration through the Flange (127 FIG. 2B, 8) of the sphere shaped vessel to allow movements of pressurized gas both in and out of the hollow interior (121 FIG. 2B) and outside of the diameter of the vertical axis of the internal Dewar Container (102) with the corresponding pipe neither directed into or out from the internal Dewar Container (102), the two way gas penetration and corresponding pipe (109) through the Flange (127 FIG. 8) is used to balance pressure between the pressure vessel (101) and a cryogenic supply prior to receiving the cryogen from a cryogenic supply, as pressures must equalize before liquids may move from the outside in, following Gas Law, and thereafter, when a cryogen is added to the Dewar Container (102 FIG. 2B) after time, the ambient temperature gas and the cryogen liquid commingle to equilibrium temperature and density, equalizing proportionate to their relative weight in the hollow interior (121) and, in addition within and surrounding the hollow interior (121) is a thermal mass heat sink the size of the weight of materials (FIG. 8) multiplied by the ambient temperature serves to warm the lighter mass gas product of the weight of the cryogen already in the process of warming, and additionally, there is one more penetration through the Flange (127), being the smallest and its corresponding pipe positioned to terminate outside the diameter of the vertical axis of the Dewar Container (102) with a purpose to bring in sensors (105 FIG. 2B) connected to communication lead wires (124) prior to adding any gas or cryogen to the present invention, these sensors (105) are for measuring the condition of the interior environment of the present invention in use, including such as temperature, pressure and the like, and to furthermore aid in calculations, and the leads (124) from the sensors (105) providing signals connect to a Micro Processor Unit (119) outside the pressure vessel (101) for the purpose of communication, commerce and service calculations and will likely interface with users cell phones and furthermore, additionally, the gas penetration and corresponding pipe (109) has branches to provide high pressure gas for use on demand from pipe (111) allowing embodiment of (FIG. 8) to serve more markets and increase usability; it branches also to allow pressure reduction step down using a low pressure through valve LPTV (108) and dispenses at (107) the low pressure gas where it will likely merge into a typical gas distribution pipeline, also the higher energy density high pressure gas dispensing for high pressure gas quick connect (118) for filling high pressure gas tanks efficiently using a flexible hose (117) connected to a less flexible supporting pole (116) which serves to keep the hose clean and off the ground.

26. The Invention of claim 25, The LNG cryogenic liquid of a gas reservoir, gasifier and high pressure natural gas and pressurized gas dispenser as claimed in claim 25, and at the low pressure gas (107 FIG. 9) is dispensed and continues in a distribution pipe (129) from the invention of claim 25 (FIG. 9), to the base of a natural gas hot water heater (130), which hot water heater has a pilot light (131) and which hot water heated is vented (131). And there is also a refrigerator/freezer cabinet (132) and a refrigeration coil (133) containing a refrigerant for this vented absorption fridge and vented hot water heater.

27. The Invention of claim 25, The LNG cryogenic liquid of a gas reservoir, gasifier and high pressure natural gas and low pressure natural gas pressurized gas dispenser as claimed in claim 25, and around the Internal Dewar Container (102 FIG. 8) at the stand (103) there is a refrigeration loop (134) containing a refrigerant capable of receiving cold thermal transfer from the cold of the liquid cryogen of a gas when it enters the Internal Dewars Container (102) through the valve penetration and associated pipe at (112) and with the refrigeration loop (134) and associated refrigeration in and out penetrations through the Flange (127) and loops at other end at freezer/refrigerator cabinet (135) to receive the cold from this refrigeration loop when it is available.

28. The Invention of claim 25, The LNG cryogenic liquid of a gas reservoir, gasifier and high pressure natural gas and low pressure natural gas pressurized gas dispenser as claimed in claim 25, and where the inclusion of a GuardX flange protection guard (FIG. 10) being comprised of an upper clam shell (160), and a lower clam shell (164) made of a durable material such as polycarbonate plastic to discourage vandalism of the flange by making the fasteners less available, covered with a bolt cover (162).

29. The Invention of claim 25, The LNG cryogenic liquid of a gas reservoir, gasifier and high pressure natural gas and low pressure natural gas pressurized gas dispenser as claimed in claim 25 and where the Cryogen is air Liquified and the gas is pressurized air and where a need exists to clean a water pipeline (FIG. 12), after making ice from the thermal exchange from the Cryogen into shapes such as examples (147-150) the gas pressurized in the present invention motivates the movement of the ice shapes (PIGS) with air pressurized which serves to scrape clean the inside of the waterline pipe.

30. The Invention of claim 25, The LNG cryogenic liquid of a gas reservoir, gasifier and high pressure natural gas and low pressure natural gas pressurized gas dispenser as claimed in claim 25, (FIG. 3, 4A) and where there exists 2 of the present invention, or one of the present invention and one of the Invention of claim 19 (FIG. 2A), together with a manifold (145) depicted at FIG. 11 where one of the invention had cool temperature internal gas, and the other one of the invention had a warmer gas, and the goal was to refuel vehicle (146) tank by the process of a “coolfastfill™” the manifold valve (145) controlling the cooler gas would fill it first and the warmer gas second to finish the fill and the resulting fill with the second warmer gas will be faster with the second gas causing the first gas to expand after it was already in the tank.

31. The Invention of claim 25, The LNG cryogenic liquid of a gas reservoir, gasifier and high pressure natural gas and low pressure natural gas pressurized gas dispenser as claimed in claim 25, where the cryogenic liquid of a gas cryogen is the liquified gases of air, and the gas is pressurized air.

32. The Invention of claim 28, The LNG cryogenic liquid of a gas reservoir, gasifier and high pressure natural gas and low pressure natural gas pressurized gas dispenser as claimed in claim 28, and where the flange GuardX (FIG. 10) containing voids on the outside radius penetrations (161) and (165) to permit fugitive emissions to escape have a coating or be impregnated with a reagent to cause visible chemical reaction, a color change or a stain as a beneficial tell tale notice as to the presence of a leak from the vessel or flange. (161 FIG. 10).

33. The LNG cryogenic liquid of a gas reservoir, gasifier and high pressure natural gas and low pressure natural as pressurized gas dispenser (FIG. 4A) as a means to supply gas, and comprised of: the external sphere shape pressure vessel (101) and the 3 leg sphere vessel stand (128) for conservation and to preserve a thermal mass of the same plate material as the pressure vessel plate pattern (FIG. 1A) for 3 of the 4 leg sections shown, and centered on top of the vessel is the post and larger diameter ball (115) for lifting and positioning, and gaged to support more than the weight of the sphere to lift and carry all (FIG. 4A) safely and also between the lifting ball (115) and sphere shaped vessel (101) is the square drive point (114) capable to receive a temporary drive gear (120 FIG. 2A, 2B) as an aid in rotational location during fabrication such as automated welding and bevel cutting of the centered circumference weld seam (125) and usable for installation of the present invention and, further the sphere pressure vessel (101) is divided into vertical and horizontal planes for the location of components and in the upper quarter of the pressure vessel sphere (101) there is a penetration at an angle off the vertical axis of the sphere pressure vessel (101) for the fitting penetration and inclusion of the Flange Fitting (126) and Flange (127), and at the bottom quarter centered horizontally within the hollow interior (121 FIG. 2B) is located the stand (103) at its lowest horizontal plane is affixed to the inside shell of the pressure vessel and where it adjoins it has a repetition number of scallop shaped voids (104) to allow movement of gas to move vertically and horizontally under and out from under the stand (103) and in the middle one half of the sphere pressure vessel hollow center (121) there is located the internal Dewar Container (102), and its bottom is attached to the top of the stand (103) and its sides rise vertical to a point to obtain its predetermined volume, and its open top positioned in line with where certain penetrations through the Flange (127 FIG. 3, 3A) and their corresponding pipes will be located and not in line with where other certain penetrations corresponding pipes will be located, as the internal Dewar Container (102 FIG. 2B) is the means for receiving cryogenic liquid and protecting the external pressure vessel shell from thermal shock of cryogenic liquid temperatures, and its volume calculation is sized approximately 1:2.4, the size of the internal volume of the sphere pressure vessel's hollow interior (121) plus the volume of the vertical pressure vessel (155 FIG. 4A) (when the Cryogen being used is LNG and the design pressure of the vessel is 5,000 psi), and further, there are located three penetrations through the Flange (127), and three corresponding pipes, and the largest penetration through the Flange (127) and corresponding pipe (112) is attached to a one way (in only) valve at its outermost point and at its innermost point terminates inside the diameter of the vertical axis of the internal Dewar Container (102 FIG. 2B for the purpose to cause cryogenic liquid from the outside to be directed into the internal Dewar Container (102) where cryogenic liquid warms to gas commingling with adjacent warm gases (113) previous introduced into the pressure vessel, and the second largest penetration located through the upper quarter portion of the horizontal plane of the sphere is the gas penetration through the Flange (127 FIG. 3, 3A) of the sphere shaped vessel (101) to allow movements of pressurized gas both in and out of the hollow interior (121 FIG. 2B) and outside of the diameter of the vertical axis of the internal Dewar Container (102) the second largest penetration is a gas penetration with the corresponding pipe neither directed into or out from the internal Dewar Container (102), the two way gas penetration and corresponding pipe (109) through the Flange (127 FIG. 4A, 2B) is used to balance pressure between the pressure vessel (101) and a cryogenic supply prior to receiving a cryogen from a cryogenic supply, as pressures must equalize before liquids may move from the outside in, following Gas Law, and thereafter when a cryogen is added to the Dewar Container (102 FIG. 2B) after time, the ambient temperature gas and the cryogen liquid commingle to equilibrium temperature and density, equalizing proportionate to their relative weight in the hollow interior (121) and, in addition within and surrounding the hollow interior (121) is a thermal mass heat sink the size of the weight of materials (FIG. 4A, 3) multiplied by the ambient temperature serves to warm the lighter mass gas product of the weight of the cryogen already in the process of warming, and additionally there is one more penetration through the Flange (127), being the smallest and its corresponding pipe positioned to terminate outside the diameter of the vertical axis of the Dewar Container (102) with a purpose to bring in sensors (105) connected to communication lead wires (124) prior to adding any gas or cryogen to the present invention, these sensors (105) are for measuring the condition of the interior environment of the present invention in use, including such as temperature, pressure and the like, and to furthermore aid in calculations, and the leads (124) from the sensors (105) providing signals connect to a Micro Processor Unit (119) outside the pressure vessel (101) for the purpose of communication, commerce and service calculations and will likely interface with users cell phones and furthermore additionally, the gas penetration and corresponding pipe (109) has branches to provide high pressure gas for use on demand from pipe (111) which is connected to an accessory vertical pressure vessel (155) for vertically conditioning the gas and providing additional gas storage, the high pressure vertical pressure vessel (155) has two pipes at the top of the vessel: the in pipe and associated valve (156) and the out pipe and associated valve (157) additionally for the embodiment of FIG. 4A, 3A to serve more high pressure markets and increase usability; additionally the embodiment branches also to allow pressure reduction step down using a low pressure through valve LPTV (108) and dispenses at (107) the low pressure gas where it will likely merge into a typical gas distribution pipeline, also the higher energy density high pressure gas dispensing for high pressure-gas quick connect (118 FIG. 4A) for filling high pressure gas tanks efficiently using a flexible hose (117) connected to a less flexible supporting pole (116) which serves to keep the hose clean and off the ground.

34. The Invention of claim 33, The LNG cryogenic liquid of a gas reservoir, gasifier and high pressure natural gas and low pressure natural gas pressurized gas dispenser as claimed in claim 33 and where inside the vertical pressure vessel (155 FIG. 4A) includes a spiral climbing tube (144) having a tube entrance near the lower end and a tube exit upper at dispensing pipe and valve (157) where the gas is beneficially warmed in the spiral climbing tube and exits conditioned to be dispensed (FIG. 4C).

35. The Invention of claim 33, The LNG cryogenic liquid of a gas reservoir, gasifier and high pressure natural gas and low pressure natural gas pressurized gas dispenser as claimed in claim 33 and where inside the vertical pressure vessel (155 FIG. 4C) includes a tube within a tube within a tube (143) having the tube entrance at entrance valve (156) at dispensing valve.
